(19) United States
(12) Patent Application Publication
(10) Pub. No.: US 2019/0102795 A1
(43) Pub. Date: Apr. 4, 2019

(54) SYSTEMS AND METHODS FOR MONITORING AND EVALUATING DATA

(71) Applicant: Apollo Program LLC, New York, NY (US)

(72) Inventors: Jillian Lee Shapiro, Brooklyn, NY (US); James Frederick Caruso, West Orange, NJ (US); Jona Mici, New York, NY (US)

(21) Appl. No.: 15/921,200

(22) Filed: Mar. 14, 2018

Related U.S. Application Data
(63) Continuation of application No. 15/722,170, filed on Oct. 2, 2017.

(51) Int. Cl. G06Q 30/02; H04L 29/08

(52) U.S. Cl. CPC G06Q 30/0255; H04L 67/306; G06Q 30/0246; H04L 67/22

(57) ABSTRACT

Systems and methods are described herein for monitoring consumer behavior on an individual level across a plurality of consumer data providers. The systems and methods described herein can receive consumer behavior data for an individual consumer. The consumer behavior data can be generated based on advertisements and digital advertisements assets relative to the individual consumer.

### CROSS-REFERENCE TO RELATED APPLICATION

This application is a continuation of U.S. patent application Ser. No. 15/722,170, filed Oct. 2, 2017, entitled “SYSTEMS AND METHODS FOR MONITORING AND EVALUATING CONSUMER DATA,” which is incorporated herein by reference in its entirety.

### TECHNICAL FIELD

This disclosure relates to systems and methods for monitoring and evaluating consumer behavior data.

### BACKGROUND

To be successful in today's competitive economic landscape, providers of goods and services must effectively and energetically market their goods and services to customers and potential customers. Such marketing typically includes using various techniques to expose consumers to brands, trademarks, and other identifiers that distinguish a provider's products and services for competitors in the marketplace. For example, marketing efforts often includes providing promotions, such as advertisements (or “ads”), to consumers to encourage consumers to purchase a product and/or service. Advertisements can be provided over a plurality of media delivery channels. When the consumer is presented with an advertisement by or on behalf of a provider of goods and/or services (e.g., a marketer, an advertiser, a retailer, or a similar entity working on behalf of the provider of goods and/or services (“content provider”)), the goals is for the consumer to better identify with the goods or services and to increase the likelihood that the consumer takes an action that benefits the provider, such as making a purchase; informing other consumers about the goods, services, or provider; blogging about the goods, services, or provider to increase awareness; and providing personal identification information (PII) that can assist the provider or content provider in serving the consumer now or in the future. To effectively target an individual consumer, content providers require consumer behavior data about the individual consumer so that marketing campaigns for the individual consumer can be tailored accordingly and, thus, increase the effectiveness of the marketing campaign. An individual consumer's behavior data can be obtained from various consumer data providers, including entities that gather information “online,” that is from consumer interactions with the Internet, social media, etc., and entities that gather information “offline,” that is from in-person interaction at the point of sale, telephone interactions and surveys, etc.

For example, marketing service providers (MSPs) have customarily provided traditional offline database marketing services, and often manage the offline customer databases, which can include the consumer behavior data. These companies are typically entrusted with consumer information and processing of such information, including identifying the consumer based on related PII. Matching providers are providers that have websites or relationship with companies having websites that can collect a consumer's PII in exchange for content or services (e.g., ring tones, coupons, giveaways, e-commerce sites, or the like). Matching providers are required to give notice to a consumer on how their consumer behavior data can be utilized, as well as an opt-out choice.

Distribution partners are digital providers that use consumer behavior data (or digital foot-print data) for targeted online advertising. Distribution partners can collect the consumer behavior data for the individual consumer. Distribution partners can also communicate with other distribution providers (or digital providers) to receive the consumer behavior data from another distribution provider for the individual consumer. Moreover, distribution partners can share the consumer behavior data for the individual consumer among one another. Distribution partners typically work only with cookies, and cannot or do not want to expose PII about individual consumers, such that privacy of individual consumers in a digital advertisement ecosystem is not compromised. Furthermore, as a result of these important concerns about privacy, in particular the use of PII in online marketing, the use of PII has been prohibited or restricted for certain online marketing applications by applicable laws or regulation, which can vary among jurisdictions. Examples of distribution partners can include an ad exchange platform, an ad network, a data management platform (DMP), or a demand-side platform (DSP).

DMPs are typically used to monitor and analyze demographic data, psychographic data, and ad tag generated data (collectively referred to as “consumer behavior data”) all in one unifying platform about the individual consumer. The consumer behavior data can be provided by a plurality of consumer data sources (e.g., other DMPs, DSPs, MSPs, matching providers, other distribution partners, customer relationship management (CRM) platforms, ad exchange platforms, advertiser platforms, or the like). These consumer data sources can provider first-party behavior data and/or third-party behavior data. DMPs function to give marketers insight into a quality and/or performance of their marketing campaigns based on the consumer behavior data for the individual consumer. DMPs can support various cookie spaces (or domains), different types of data providers and media providers, as well as connect to different inventory source providers (e.g., impression opportunity providers).

Data source providers can facilitate the serving of advertisements to the individual consumer (e.g., deliver advertisements to the consumers or cause (or participate in causing) advertisements to be delivered to the individual consumer). An advertisement can be served to the individual consumer via one or more reserved impression opportunities of a respective media delivery channel. Each data source provider can monitor individual consumers across associated media delivery channels by using unique identifier (ID), and can provider consumer behavior data characterizing a behavior of the individual consumer in relation to the advertisement. A given data source provider can pass a corresponding unique ID to the data source provider, which can allow the marketer to monitor individual consumer across the media channels associated with the given data source provider.

### SUMMARY

In an example, a system can include a non-transitory memory to store machine readable instructions and a processor to access the non-transitory memory and execute the machine readable instructions. The machine readable instructions can include a sync and monitoring engine module. The sync and monitoring engine module can be programmed to transmit a sync request to each consumer data provider based on consumer data provider (CDP) identifier (ID) data can include a CDP ID identifying a respective CDP. Each of the CDPs can be configured to provide behavior data characterizing a behavior of the individual consumer based on one or more advertisements served to one or more consumer devices associated with the individual consumer during an advertising campaign. The sync and monitoring engine module can further be programmed to generate a unique consumer monitoring platform (CMP) ID for each individual consumer and cause each of the CDPs to generate consumer sync data. The consumer sync data can characterize an association between the unique CMP ID and a unique consumer CDP ID for each individual consumer. The sync and monitoring engine module can further be programmed to receive the consumer sync data from each of the CDPs, associate the unique CMP ID with a unique asset ID related to a digital advertisement asset based on the consumer sync data, such that the unique asset ID is associated with the unique customer CDP ID, and generate an association table characterizing the association between the unique CMP ID, the unique asset ID and the unique customer CDP ID. The sync and monitoring engine module can further be programmed to monitor the individual consumer for the behavior data across each of the consumer data providers based on the association table.

In another example, a computer-implemented method can include transmitting a sync request to each consumer data provider based on consumer data provider (CDP) identifier (ID) data comprising a CDP ID identifying a respective CDP. Each of the CDPs can be configured to provide behavior data characterizing a behavior of the individual consumer based on one or more advertisements served to one or more consumer devices associated with the individual consumer during an advertising campaign. The computer-implemented method can further include generating a unique consumer monitoring platform (CMP) ID for each individual consumer, causing each of the CDPs to generate consumer sync data. The consumer sync data can characterize an association between the unique CMP ID and a unique consumer CDP ID for each individual consumer. The computer-implemented method can further include receiving the consumer sync data from each of the CDPs. Moreover, the computer-implemented method can include associating the unique CMP ID with a unique asset ID related to a digital advertisement asset based on the consumer sync data, such that the unique asset ID is associated with the unique customer CDP ID, generating an association table characterizing the association between the unique CMP ID, the unique asset ID and the unique customer CDP ID, and monitoring the individual consumer for the behavior data across each of the consumer data providers based on the association table.

This Summary is provided merely for purposes of summarizing some example embodiments to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

Features, objects and advantages other than those set forth above will become more readily apparent when consideration is given to the detailed description below. Such detailed description makes reference to the following drawings.

FIG. 1 illustrates an exemplary digital advertising environment for a consumer management platform (CMP).

FIG. 2 schematically illustrates an exemplary CMP for monitoring and evaluating consumer behavior data over a plurality of consumer data providers, such as illustrated in FIG. 1.

FIG. 3 schematically illustrates an exemplary computing environment in which systems and methods described herein can be implemented.

FIG. 4 illustrates an example of a registration graphical user interface (GUI).

FIG. 5 illustrates an example of an administration GUI.

FIG. 6 illustrates an example of a create a new account GUI.

FIG. 7 illustrates an example of a new brand name GUI.

FIG. 8 illustrates an example of a pixel GUI.

FIG. 9 illustrates an example of a create a new sync partner GUI.

FIG. 10 illustrates an example of a create a new partner pixel type GUI.

FIG. 11 illustrates an example of a create a new parameter type GUI.

FIG. 12 illustrates an example of a create a new parameter GUI.

FIG. 13 illustrates an example of a create a new parameter group GUI.

FIG. 14 illustrates an example of a create a new format GUI.

FIG. 15 illustrates an example of a create a new delivery method GUI.

FIG. 16 illustrates an example of a create a new pixel GUI.

FIG. 17 illustrates an example of a project manager GUI.

FIG. 18 illustrates an example of a create a new project GUI.

FIG. 19 illustrates an example of a reporting manager GUI.

FIG. 20 illustrates an example of a create a new user pool GUI.

FIG. 21 illustrates an example of a create a new report GUI.

FIG. 22 illustrates an example of a create a new deliverable GUI.

FIG. 23 illustrates an example of a user pool page GUI.

FIG. 24 illustrates an example of a pixel list page.

FIG. 25 illustrates an example of a pixel monitoring page.

FIGS. 26-33 are directed to a plurality of GUI's illustrating the reports created according the systems and methods described herein.

FIG. 34 is a flow diagram illustrating an exemplary method for monitoring and evaluating consumer behavior data over a plurality of consumer data providers.

### DETAILED DESCRIPTION

Data source providers assign unique identifiers (IDs) to individual consumers to monitor their behavior on media delivery channels according to an established identification scheme. As each data source provider is configured to use a unique identification scheme and deliver consumer data without any personal identification information (PII) existing consumer behavior systems cannot tracking on an individual level consumers (e.g., their behavior) across a plurality of data source providers. Thus, existing systems cannot effectively measure a quality of the marketing campaign relative to each individual consumer across each of the consumer data providers. Likewise, existing systems cannot evaluate the consumer data associated with a given individual consumer provided by a given data source provider. Moreover, performing marketing analytics across the data source providers by use of existing systems is not possible, which is important to an effectiveness, attribution and accuracy rate of the marketing campaign.

Furthermore, digital media assets (or digital assets), such as advertisements, have become more and more ubiquitous in a digital age. A digital asset management (DAM) platform can provide for marketing support across the different media delivery channels. That is, a marketer can use the DAM platform to facilitate delivery of digital marketing content (e.g., advertisements) to the individual consumer. For example, the DAM platform can be used produce a video file that can include a digital marketing asset (e.g., an advertisement) supplied by a marketer associated with a marketing campaign. The DAM platform can be configured to communicate with a particular data source provider system, such as a demand-side-platform (DSP), for delivery of the digital advertisement asset to consumers. However, currently existing systems are not configured to provide metadata associated with the digital marketing asset such that a more complete picture of the marketing campaign can be provided for the individual consumer. In some examples, the received metadata can be part of consumer asset data based on the digital marketing asset being served, and can provide an additional insight into the individual consumer's behavior, and ultimately a quality and/or performance of the marketing campaign for the individual consumer. In addition, existing systems cannot associate consumer asset data generated based on the digital marketing asset being served with consumer behavior data generated based on the individual consumer's behavior relative to an impression opportunity across each the plurality of data providers.

Systems and methods are described herein for monitoring and evaluating consumer behavior data. In some examples, the systems described herein can monitor consumer behavior on an individual level anonymously across a plurality of consumer data providers without the need for personal identification information (PII) in contrast to existing consumer behavior systems. Thus, the systems described herein can maintain a consumer's privacy and comply with relevant laws and regulations in a corresponding jurisdiction. Therefore, the systems described herein allow for monitoring an individual consumer in a digital ecosystem without compromising the consumer's anonymity. As such, the systems described can effectively measure a quality of the marketing campaign relative to each individual consumer across each of the consumer data providers. Thus, the quality of the marketing campaign can be determined on an individual consumer level by using consumer behavior data provided by each of the plurality of consumer data providers.

Each consumer data provider uses a unique identification scheme for identifying individual consumers, and thereby making it difficult to identify consumer behavior data for the individual consumer across each data provider. The systems described herein allow the individual consumer to be identified across each of the plurality of consumer data providers. Therefore, consumer behavior data associated with the individual consumer provided by each consumer data provider can be readily identified, aggregated and analyzed by the systems described herein to provide a more complete insight on a quality of the advertisement campaign for the individual consumer. Accordingly, the systems described herein have technical advantages and make an improvement over existing consumer behavior systems by being able to identify consumer behavior data for each individual across a plurality of different data providers each of which can use their own identification scheme for tracking individuals.

Furthermore, the systems described can use the consumer behavior data for each individual consumer provided by each of the plurality of consumer data providers to deliver a more complete picture of the quality of the advertisement campaign. Thus, the systems described herein perform richer (e.g., more complete) marketing analytics for the advertisement campaign since the individual consumer can be identified and monitored across each of the plurality of consumer data providers. Even further, the systems described herein can evaluate consumer data associated with a given individual consumer provided by a given data source provider, and perform marketing analytics across data source providers to improve an effectiveness, attribution, and accuracy rate of a marketing campaign.

Moreover, the systems described herein can receive metadata associated with one or more digital advertisement assets (or digital marketing assets) supplied by a digital asset management (DAP) platform to provide additional insight into the advertisement campaign for the individual consumer. The plurality of consumer data providers can distribute the one or more digital advertisement assets to the individual consumer over a corresponding media delivery channel and ultimately to one or more consumer devices associated with the individual consumer. Metadata associated with the digital advertisement asset can form part of consumer asset data generated based on the digital advertisement asset being served to the individual consumer. The consumer asset data can provide an additional insight into the individual consumer's behavior. The systems and methods described herein can associate the consumer asset data generated based on the digital advertisement asset being served with consumer behavior data. The consumer behavior data is generated based on the individual consumer's behavior relative to an impression opportunity (or opportunities) across each the plurality of data providers. As such, the systems the systems described herein have technical advantages and make an improvement over existing consumer behavior systems by providing a more complete picture of consumer behavior. The advantages and technical improvements that the systems described herein have over currently available consumer behavior systems will become more readily apparent and better appreciated by the examples described herein.

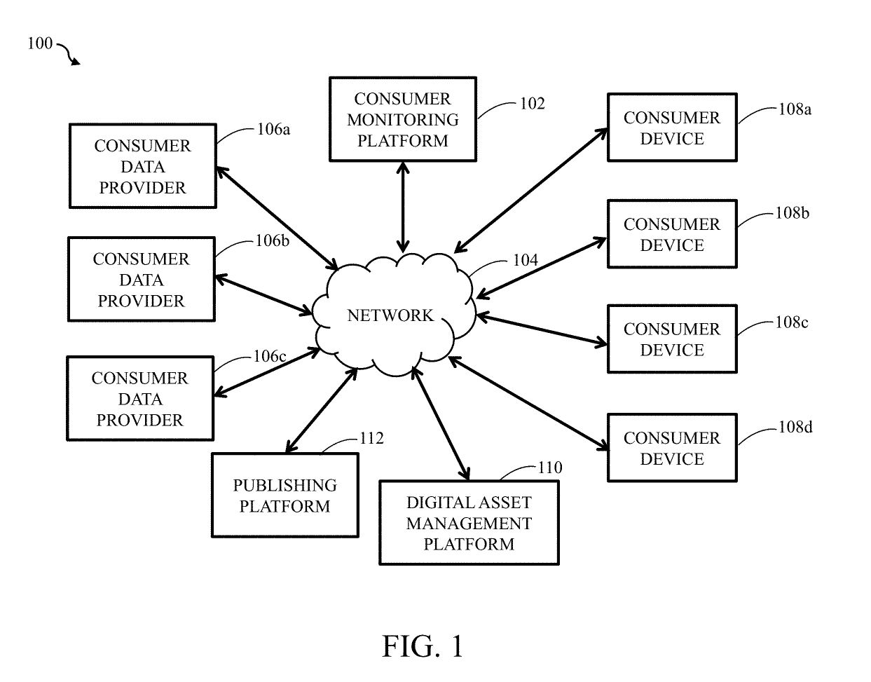

FIG. 1 illustrates a digital advertisement environment 100 for implementation of the systems and methods described herein. The digital environment 100 can include a consumer monitoring platform (CMP) 102. The CMP 102 can be configured to monitor and evaluate consumer behavior data associated with a plurality of consumers on an individual consumer level. The CMP 102 can be configured to communicate over a network 102 with a plurality of consumer data providers 106a, 106b and 106c of the digital advertisement environment 100. The consumer data providers 106a, 106b and 106c can be referred to herein collectively as “consumer data providers 106a-c.” Each of the consumer data providers 106a-c can be configured to receive and/or retrieve consumer behavior data for each individual consumer across respective media delivery channels.

A media delivery channel can include any digital channel through which consumers can access and/or receive media content data. In some examples, the media content data can include advertisement content data. The media content data can include, but not limited to, a radio, social media (e.g., online networks, such as Facebook®, Twitter®, LinkedIn®, or the like), webpages, applications (e.g., mobile apps and/or desktop apps), connected television channels or devices, internet content platforms, live video streams, including television streams and online video stream, digital out-of-home, virtual or augmented reality platforms, wearable devices, or the like.

Although FIG. 1 illustrates the CMP 102 in communication over the network 102 with only three consumer data providers, e.g., the consumer data providers 106a-c, the CMP 102 can be in communication with any number of consumer data providers. Each of the consumer data providers 106a-c can be configured to communicate with one another to share related consumer behavior data for an individual consumer. In an example, the sharing can include a cookie sync process to enable respective consumer behavior data providers to identify the consumer behavior data for the individual consumer over respective systems. Thus, a given data source provider can include consumer behavior data received and/or collected by another data source provider for the individual consumer.

The consumer behavior data can include, but not limited to, first-party data and/or third-party data. First-party data can include data collected directly from the individual consumer (e.g., an entity, such as a retailer, an audience and/or a customer). First-party data can include, but not limited to, at least one of cookie-based data, which can include information gathered from a website(s) hosted by a publishing platform, customer relation management (CRM) data, data obtained from consumer polling, subscription data, social data, or cross-platform data from a mobile web or apps, user inputted data, such as, but not limited to, demographical data (e.g., a user's age, gender income, highest attained education level, location, or the like), psychographic data, which can reflect the user's interest or content affinity (e.g., sports, movies, music, travel, likes, dislikes, finance, or the like), ad tag generated data (e.g., impressions, clicks, actions associated with an advertisement, or the like), or the like.

Third-party data can include data collected in-directly from the individual consumer. Third-party data providers can include, but not limited to, a DSP, an ad exchange server, an advertising server, or the like. In some examples, the third-party data can include at least similar data as the first-party data, but which has been collected by an entity other than an entity directly associated with the individual consumer. The third-party data can further include at least one of a consumers Internet Protocol (IP) host address, browser types (e.g., Chrome, Firefox, Internet Explorer, or the like), date and time of an ad request, pages viewed, consumers operating system (e.g., Macintosh, Windows, Android, macOS (OSX), or the like), a URL or App that the consumer is using, Internet Service Provider (ISP) (e.g., Verizon, Comcast, AT&T, Cox Communications, or the like), language, amount of time spend on a particular web page, a number of links clicked by the individual consumer, search terms, consumer mobile specification data, device type, make and model, device operating system, mobile advertising identifiers, operating system device identifier (e.g., identifier for advertisers (IDFA) for iOS, Android ID for an Android, or the like), apps data associated with apps that the individual consumer uses, GPS information associated with the consumer mobile device, or the like.

The consumer data providers 106a-c can be configured to communicate over the network 104 with one or more consumer devices 108a, 108b, 108c, and 108d. The one or more consumer devices 108a, 108b, 108c, and 108d can be referred to herein collectively as “consumers devices 108a-d.” The consumer data providers 106a-c can further be configured to communicate with a digital asset management (DAM) platform 110, and/or a publishing platform 112. FIG. 1 illustrates the consumer data providers 106a-c in communication over the network 104 with only four consumer devices, e.g., the consumer devices 108a-d. However, the consumer data providers 106a-c can be in communication with any number of consumer devices. The consumer data providers 106a-c can include, but not limited to, one or more DSPs, one or more data management platforms (DMPs), one or more advertisement (“ad”) exchange servers, one or more advertiser servers, one or more media providers, or one or more systems configured for monitoring and collecting consumer behavior data for individual consumers. For example, the consumer data providers 106a-c can include, but not limited to, BeesWax, GrapeShot, Experian, LiveRamp an Axciom Company, Kantar Media, Kochava, or the like.

The network 104 can be any type and/or form of network and can include at least one of the following: a point-to-point network, a broadcast network, a wide area network, a local area network, a telecommunications network, a data communication network, a computer network, an Asynchronous Transfer Mode (ATM) network, a Synchronous Optical Network (SONET) network, a Synchronous Digital Hierarchy (SDH) network, a wireless network and a wireline network. In an example, the network 104 can include a wireless link, such as an infrared channel or a satellite band. The topology of the network 104 can be a bus, star, or ring network topology. In an even further example, the network 104 can be of any such network topology that can support the one or more operations and functions described herein. The network 104 can include mobile telephone networks utilizing any protocol or protocols used to communicate among mobile devices, including Advanced Mobile Phone System (AMPS), Time-Division Multiple Access (TDMA), Code-Division Multiple Access (CDMA), Global System for Mobile Communications (GSM), General Packet Radio Service (GPRS) or Universal Mobile Telecommunication Systems (UMTS), or the like.

The CMP 102 can be configured to communicate with the consumer data providers 106a-c, the consumer devices 108a-d, the publishing platform 112 and/or the DAM platform 112 over any suitable communication channel using any suitable communication protocol over the network 104. Likewise, the consumer data providers 106a-c can be configured to communicate over the network 104 with the consumers devices 108a-d, the DAM platform 110, and/or the publishing platform 112 over any suitable communication channel using any suitable communication protocol over the network 104.

A suitable communication protocol can include, but not limited to, TCP/IP communication protocols, Internetwork Packet Exchange (IPX), Appletalk, Internet Protocol Version 6 (IPv6), Network Basic Input/Output System (NetBIOS), Open System Interconnection (OSI), any tunneling protocol (e.g., Internet Protocol Security (IPsec), Secure Shell (SSH), or the like). A suitable communication channel can include a telephone network, an extranet, an intranet, Internet, online communications, satellite communications, wireless communication, local area network (LAN), wide area network (WAN), virtual private network (VPN), or the like. In an example, the network 104 can include a plurality of networks. Additionally, or alternatively, the network 104 can include a private network, a public network, or a combination thereof. In an even further example, the network 104 can include only private networks or public networks.

In an example, the network 104 can be one of secured, unsecured, or a combination thereof. Thus, the communication over the unsecured network can utilize data encryption. Encryption can be performed by way of any currently available encryption techniques or future available techniques, such as Twofish, RSA, El Gamal, Schorr signature, Digital Signature Algorithm (DSA), Pretty Good Privacy (PGP), Public Key Infrastructure (PKI), GPG (GnuPG), symmetric cryptosystems, non-symmetric cryptosystems, or the like.

The consumer devices 108a-d can include any device that can receive and display electronic media (e.g., an advertisement, a digital advertisement asset, or a combination thereof) through a media delivery channel, which a publisher can use to provide data that can include the electronic media to the consumer. For example, the consumer devices 108a-d can include, but not limited to, a computer, a laptop, a notebook, a hand-held computer, a personal digital assistant (PDA), a cellular phone, a smart phone (e.g., an iPhone®, a Blackberry®, a Droid®, or the like), a tablet, a digital audio player (e.g., IPOD®) wearable devices (e.g., a smart watch, smart glasses), a television (TV) system, a global positioning system (GPS), or the like.

The CMP 102 can be configured to facilitate an advertisement campaign (or a marketing campaign). An advertising campaign is a plan, by an advertiser, to deliver advertising content to a targeted group of consumers (or individual consumer(s)). An advertiser can be any individual, group of people, company, or any other enterprise, that desires to have advertisements embedded in the content of publishers. The campaign can include, but not limited to, a selection of advertising content, such as a particular advertisement or various forms of an advertisement, or a sequence of related advertisements intended to be viewed in a particular order, as well as a period of time for which the campaign is to run. The CMP 102 can be configured to receive campaign description data, for example, at an input device associated with the BMP 102 (not illustrated in FIG. 1). The input device can include, but not limited to, a keyboard, a mouse, or any device that can receive information from the advertiser.

The campaign description data can include, but not limited to, categories of the consumer devices 108a-d to target, or a schedule for sequential delivery of advertising content to the consumer devices 108a-d. The campaign description data can include, but not limited to, impression reporting, clicks, post-clicks, description of the targeted consumer group, bidding rules, or advertising campaign related information. The target consumer group can be defined by one or more selected parameter, such as demographics (e.g., age range, gender, income, etc.), geographic location (e.g., zip code, a latitude and longitude, or the like), content consumption, technology usage or device information, purchase data, or the like. Additionally or alternatively, the campaign description data can include financial constraints, such as a budget, a number of consumers to target, or other financial or non-financial constraints (e.g., frequency capping, time-of-day, inventory availability, ad viewability, or the like)

The CMP 102 can be configured to communicate the campaign description data to the consumer data providers 106a-c. The consumer data providers 106a-c can be configured to facilitate delivery of advertising content to the consumer devices 108a-d associated with the individual consumer based on the campaign description data for the advertising campaign. The facilitation can include a bidding process, including real-time bidding (RTB) and non-real-time bidding (NRTB) based on the campaign description data. For example, a given DSP can place bids on advertising inventory (or one or more impression opportunities) based on the campaign description data. The bid can be submitted by the DSP to a supply-side provider (SSP), which can function as an intermediary that can take advertising inventory from a corresponding media conduit and make the inventory available to the DSP, optionally via an ad exchange server. Advertisers can purchase or bid on the advertising inventory when deciding on how to deliver advertising content to the individual consumer. In some examples, the SSP can interact directly with the DSP without the need of the ad exchange server, such as in instances wherein functions of the ad exchange serve can be formed by either one or both of the DSP and SSP. Thus, the DSP can take on a complete role of the ad exchange server.

The CMP 102 can be configured to communicate with a plurality of different DSPs, such that advertisers can bid on advertisement inventory associated with a plurality of different publishers over a variety of different SSPs and/or ad exchange servers based on the campaign description data for the advertisement campaign. A publisher can be referred to as an entity that owns, creates, or allocates an impression opportunity (or advertising inventory). An impression refers to any instance in which an advertisement reaches a consumer, such as at the consumer devices 108a-d. In an example, an SSP can include SPotX, WideOrbit, or the like. For a winning bid, the DSP (or the ad exchange server from the SSP) can provide the advertisement content data to the media delivery channel for delivery ultimately, to the individual consumer. The DSP can communicate with an ad server (or ad network) (not illustrated in FIG. 1) to retrieve the advertisement content data for delivery over the media delivery channel, for example, in response to the SSP (or the ad exchange server). An ad server can correspond to a server that can store, maintain and upload advertising content associated with an advertiser.

The digital advertisement environment 100 can further include the DAM platform 110. In some examples, the DAM platform 110 can be a stand-alone platform, and as a separate platform from the CMP 102. It is standard industry practice to keep the DAM platform 110 as a stand-alone platform from the CMP 102. In another example, the DAM platform 110 can be part of the CMP 102, and the CMP 102 can perform the functionality of the DAM platform 110. The DAM platform 110 can include services and/or applications related to management of digital assets, including digital advertising assets and digital non-advertising assets. The DAM platform 100 can be configured to store digital advertisement assets and/or non-digital assets. The DAM platform 110 can be configured to enable users to manage the location of digital assets within organized folder structures and categories. Digital content can be modified, deleted, copied, pasted and added in response to user input, for example, at the user input device associated with the CMP 102. Folders can store any asset type configured by administrators, including, but not limited to, video, audio, and/or images, including static and/or dynamic images. As used herein, a “digital advertising asset” can include any type of digital advertisement content that can be provided to the consumer devices 108a-d associated with the individual consumer including, but not limited to, animated graphics, videos, which can include animated and non-animated videos, audio, audio-video, and video frames.

The digital advertisement assets can be stored in the memory of the DAM platform 110 (not illustrated in FIG. 1), and can be provided to the CMP 102. The DAM platform 110 can be configured to store a plurality of different versions of the asset. For example, a second version of the asset can include additional information (e.g., additional video frames and/or audio frames) relative to a first version of the asset. Each digital advertisement asset can be associated with metadata characterizing the digital advertisement. In some examples, different digital advertisement assets can be associated with similar metadata.

Metadata for each digital advertisement asset can include core metadata, custom metadata, and/or automated metadata. The core metadata can include client information, brand information, and/or projection information, and can be used by the DAM platform 110 to regulate permissions of a user, such as the advertiser, interacting with the DAM platform 110 (e.g., which user of the DAM platform 110 has access to a particular digital asset). Core metadata can further include ad asset title information, ad description information, ad created and/or updated information, or the like. Custom metadata can include user created fields, field groups, fields set, or the like. Automated metadata can include folder-based metadata, such that when digital advertisements assets are imported into the DAM platform 110, folder elements can be mapped to appropriate metadata fields. Automated metadata can further include Extensible Metadata Platform (XMP)/File metadata. As will be described herein, the DAM platform 110 can be configured to publish metadata about digital advertisement assets to a database including consumer data from multiple providers 106a-c for analysis on a consumer identifier (ID) and asset ID level.

The digital advertisement environment 100 can further include one or more publishing platforms 112 (which can be referred to herein as a “publishing platform 112”). The publishing platform 112 can be configured to communicate with the consumer data providers 106a-c, the consumer devices 108a-d, and/or the DAM platform 110. The publishing platform 112 can be configured to facilitate delivery of (or deliver) the media content data and/or the advertisement content data to the consumer devices 108a-d. In some examples, the publishing platform 112 can be configured to deliver an asset to a webpage that can provide an impression opportunity to the consumer devices 108a-d. For example, the impression opportunity can include any form or type of space or region on the webpage. This space or region can overlap with or reside within (or as part of) content on the webpage (e.g., locations for banners, ad blocks, sponsored listings, margin ads and flash displays). The impression opportunity can be temporal, e.g., associated with a time slot (e.g., screening of a sponsored video footage prior to a requested screening, or available on a part of a day referred to as a day part).

Additionally, or alternatively, the impression opportunity can reside not directly on the webpage. For instance, the impression opportunity can be generated from the webpage, such as due to consumer action. In an example, when the webpage is loaded onto a browser of an associated consumer device, a pop-up can be generated. A window display or other widget can be generated in response to a mouse-over action by the individual consumer. An impression opportunity can include one or more elements generated based on the advertisement content data. For example, the impression opportunity can include, but not limited to, a banner, an animated flash display extending from a banner boundary, a video, graphical image, text, audio, or the like. In some examples, elements that can individually qualify as an impression opportunity can be collectively packaged as a single impression opportunity.

The publishing platform 112 can be configured to generate a network path to the webpage by generating a Uniform Resource Locator (URL) for the webpage. The publishing platform 112 can provide the individual consumer access to the webpage, which the consumer can access over network 104, such as the Internet, via the URL. The webpage can cause one or more cookies to be placed on the one or more consumer devices 104. The one or more cookies can include, but not limited to, a first party cookie and a third-party cookie. Thus, the cookie can include the first-party data and/or the third-party data.

A cookie can be referred to as a data file that can include executable code and/or information associated with the individual consumer of the consumer device, such as the consumer behavior data. For example, the cookie can include information characterizing the consumer's browsing activity, including but not limited to, clicking of particular buttons, logging in, recording which pages were visited in the past, PII, such as names, addresses, passwords, and credit card numbers, or the like. In an example, the third-party cookie can correspond to a cookie ID, which can provide anonymity for the individual consumer from the consumer data providers 106a-c. Thus, the cookie ID can be used to maintain an identity of the individual consumer relative to the consumer data providers 106a-c (e.g., when the consumer data providers share the consumer behavior data for the individual consumer among one another). Therefore, the consumer data providers 106a-c can receive the consumer behavior data for the individual consumer, but not be readily aware of the identity of the individual consumer. Accordingly, a cookie can include the consumer behavior data, but not include PII and/or information that can readily identify the individual consumer, such as specific audience segmented information.

The word “party” in relation to a cookie can refer to a domain as specified in a corresponding cookie, e.g., the website that can be placing the cookie, or in different terms an owner of the cookie being placed. A first-party cookie is a cookie generated by the webpage that is served to the consumer device. For example, if the consumer visits www.site.com, and that webpage contains embedded first party code to set a cookie, then that cookie will be set with “site.com” as its domain. A third-party cookie can refer to a cookie generated by the website (e.g., a third-party website) other that the website served to the consumer device. For example, if the consumer visits www.site.com, and that site contains embedded third-party code that retrieves ad content from www.adnetwork.com, that are not on the site.com domain, then the cookie will be set with “adnetwork.com” as its domain. Use of third-party code enables the consumer data providers 106a-c, such as DSPs, to monitor the behavior of the individual consumer across associated media delivery channels for the advertisement campaign.

In an example, the CMP 102 can be configured communicate with each of the consumer data providers 106a-c and perform a consumer identification sync, such that the individual consumer's behavior can be monitored anonymously across each of the consumer data providers 106a-c. That is, the CMP 102 can be configured monitor the individual consumers behavior across each of the consumer data providers 106a-c without any information associated with an identity of the user, such as the individual consumer's PII. The CMP 102 can be configured to transmit a sync request to each of the consumer data providers 106a-c based on consumer data provider (CDP) ID data. The CDP ID data can include information that can identify a respective consumer data provider, such as a CDP ID. Each of the consumer data providers 106a-c can be configured to transmit a confirmation message confirming sync participation in the consumer identification sync.

The CMP 102 can be configured to generate a unique consumer monitoring platform (CMP) ID for each individual consumer. The CMP 102 can be configured to transmit the unique CMP ID to each of the consumer data providers 106a-c in response to receiving the confirmation message. Alternatively, the CMP 102 can be configured to transmit the sync request that includes the unique CMP ID. The unique CMP ID can include the CDP ID. Each of the consumers data providers 106a-c can be configured to generate consumer sync data based on unique CMP ID. The consumer sync data can characterize an association between the unique CMP ID and a unique consumer CDP ID assigned by a respective consumer data provider for the individual consumer. The unique consumer CDP ID can include a WebID, a device ID, or a combination therefor that can be associated with the consumer behavior data generated for the individual consumer. Accordingly, the consumer sync data can characterize the association between the unique CMP ID and the unique consumer CDP ID for each of the consumer data providers 106a-c. The consumer sync data can include the CDP ID.

Each of the consumer data providers 106a-c can be configured to transmit respective consumer sync data to the CMP 102. The CMP 102 can further be configured to associate the unique CMP ID with a unique asset ID related to a digital advertisement asset based on the consumer sync data, such that the unique asset ID is associated with the unique customer CDP ID. The CMP 102 can further be configured to generate an association table characterizing the association between the unique CMP ID, the unique asset ID and the unique customer CDP ID. The CMP 102 can be configured to periodically communicate with each of the consumer data providers 106a-c to update the association table based on new unique CMP ID data. The CMP 102 can be configured to monitor the individual consumer for the behavior data across each of the consumer data providers based on the association table. The consumer data can include behavior information generated in response to digital advertisement assets, as well as non-asset advertisements.

The CMP 102 can be configured to generate a CMP page tag for advertisement content data that can be served (e.g., in a corresponding impression opportunity) during the advertising campaign to the consumer devices 108a-d associated with individual consumer based on the unique CMP ID. A CMP page tag can include a CMP pixel tag or a JavaScript CMP tag. The CMP 102 can be configured to generate CMP page tags that can include page tag properties. The one or more page tag properties can include, but not limited to, a unique CMP ID (e.g., “CMP_USER_ID”), a name, description, account, format, delivery method, a create date, or a combination thereof. The CMP 102 can further be configured to generate an asset CMP tag for each digital advertisement asset that can be served (e.g., in a corresponding impression opportunity) during the advertising campaign to the consumer devices 108a-d based on the unique asset ID. An asset ID macro (“ASSET_ID”) of the asset pixel tag can serve as a link between the consumer data providers 106a-106c and the DAM platform 110 and enable tracking of individual consumers. The individual consumers behavior can be evaluated based on consumer behavior data provided by the one or more consumer data providers and asset data (e.g., metadata) provided by the one or more DAM systems.

The CMP 102 can be configured to transmit the CMP tag and/or the asset CMP tag with (or part of) the campaign description data to the consumer data providers 106a-c. Alternatively, the CMP 102 can be configured to transmit the CMP page tag and/or the CMP asset tag (directly or indirectly) at a later time relative to a time that the campaign description data was transmitted, and/or in response to a tag request(s) provided by (or on behalf of) the consumer data providers 106a-c based on data received at the publishing platform 112, such as for example, generated at the consumer devices 108a-d. Each of the asset CMP tags and the CMP page tags can be transmitted to a corresponding CDP. Each CDP can generate unique CDP IDs upon serving of the digital advertisement asset and the impression opportunity, such that during the serving, the CMP page tag is served with the advertisement content data and the asset tag is served with the digital advertisement asset, to connect CMP ID, CDP ID, and asset ID. Serving of the advertisement content data and/or the digital advertisement asset can include, but not limited to, visiting the webpage, initiating the associated advertisement, performing an actionable event with respect to the webpage, or the like. When serving occurs, the plurality of tags can “fire” (in some instances simultaneously).

The CDP tag can notify each of the consumer data providers 106a-c and generate a CDP cookie based on information provided by the consumer data providers 106a-c. The CDP cookie can include data identifying the individual consumer, such as the unique consumer CDP ID, and the consumer behavior data characterizing the individual consumer behaviors associated with the one or more impression opportunities. The CDP cookie can be stored locally on the consumer devices 108a-d. The CDP cookie ID can include the unique consumer CDP ID. In another example, the CDP tag can generate a CDP cookie ID identifying the individual consumer and cause the consumer behavior data to be transmitted to the consumer data providers 106a-c for storage in an associated behavior database, a cloud, or the like. In an example, the consumer data providers 106a-c can generate the CDP cookie ID and place the cookie ID on the consumer devices 108a-d in response to the CDP tag. If the individual consumer does not have an assigned unique consumer CDP ID, the consumer data providers 106a-c can be configured to assign a unique consumer CDP ID to the individual consumer and transmit the CDP cookie ID to the consumer devices 108a-d.

The CMP page tag can notify the CMP 102 and pass the unique CMP ID associated with the impression opportunity to the CMP 102. That is, the CMP 102 can be configured to receive a tag notification comprising the unique CMP ID in response to the serving of the CMP page tag. The CMP 102 can be configured to evaluate the unique CMP ID of the tag notification relative to the association table to determine the unique customer CDP ID for the individual consumer for each CDP. The CMP asset tag can notify the CMP 102 and pass the unique asset ID associated with digital advertisement asset to the CMP 102. The CMP 102 can be configured to evaluate the unique asset ID of the asset notification relative to the association table to determine the unique customer CDP ID for the individual consumer for each CDP.

The CMP 102 can be configured to communicate a consumer data request for the individual consumer to the consumer data providers 106a-c based on the evaluation. The consumer data providers 106a-c can be configured to transmit the consumer behavior data and the consumer asset data for the individual consumer in response to the consumer data request. The consumer asset data can include metadata for the served digital advertisement asset. Alternatively, the CMP 102 can further be configured to communicate to the DAM 110 to receive the metadata for the served asset based on the evaluation. The CMP 102 can be configured to evaluate the consumer behavior data and/or the consumer asset for the individual consumer. The evaluation can include apply marketing analytics, such as marketing statistics, as described herein. The CMP 102 can be configured to adjust parameters of the advertisement campaign based on a result of the evaluation to adjust advertisements delivered to the individual in the future such that more relevant (or more personal advertisements) can be delivered to the individual consumer.

The CMP 102 can be configured to evaluate the consumer behavior data and the consumer asset data for the individual consumer across the plurality of data providers 106a-c for delivery of quality personalized advertisements to the individual consumer for an associated advertisement campaign. Thus, the CMP 102 can reduce a need for excessive advertisements (e.g., by personalizing the advertisements delivered to a particular consumer). Moreover the computing, power and memory requirements of the CMP 102 can be substantially reduced since less data needs to be processed by the CMP 102. That is, by evaluating the consumer behavior data and the consumer asset data for the individual consumer across the plurality of data providers 106a-c, substantially less data needs to be processed (e.g., during application of the marketing analytics to the data) by the CMP 102 since the advertisements delivered to have been tailored more accurately to the individual consumer. Accordingly, technical barriers currently existing in digital advertisement can be overcome by the CMP 102 by combining consumer behavior data with the consumer asset data across the consumer data providers 106a-c, such that quality personalized advertisements can presented at the one or more consumer devices 108a-d associated with the individual consumer.

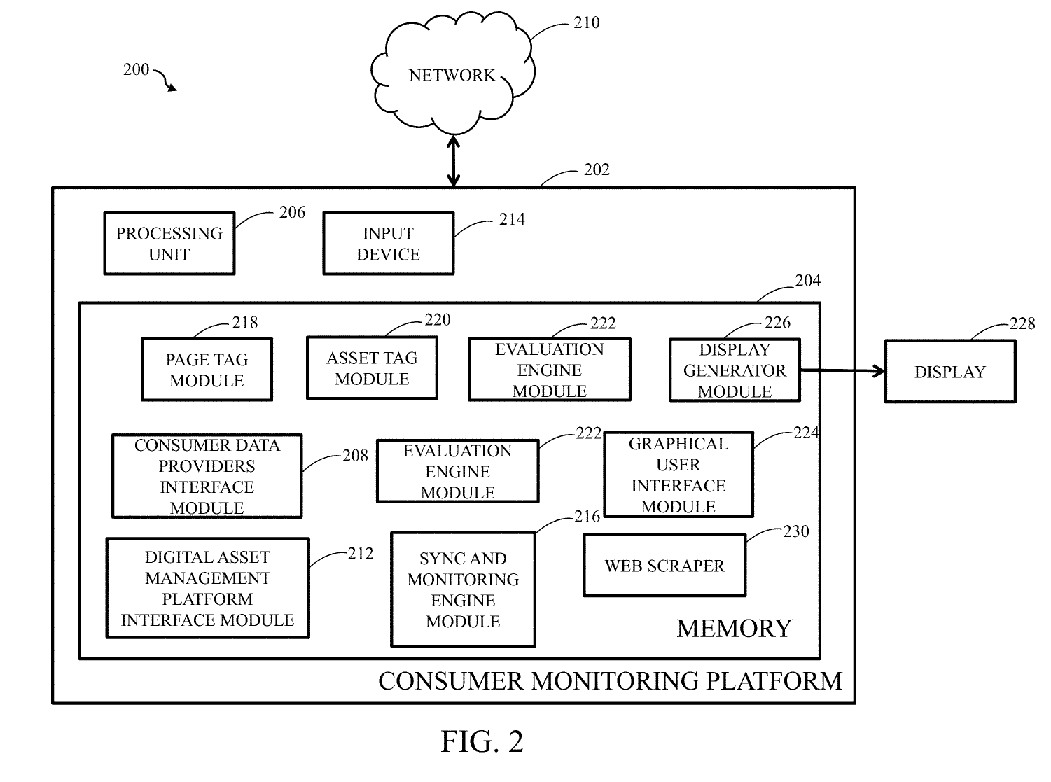

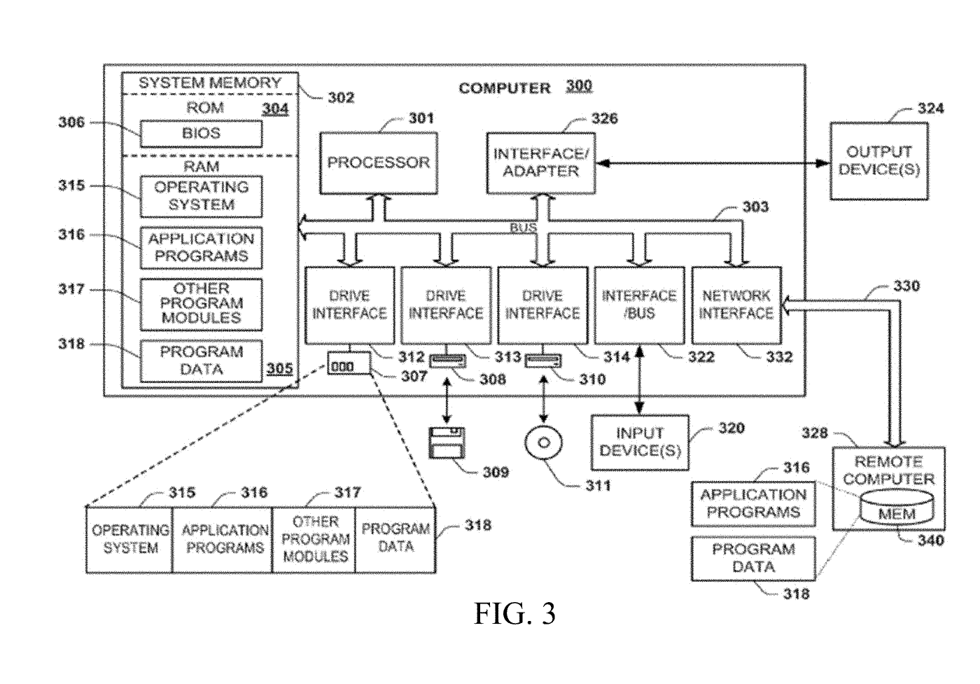

FIG. 2 illustrates an example of a consumer monitoring platform (CMP) 202 for monitoring and evaluating consumer behavior data. In some examples, the CMP 202 can be implemented substantially similar to the CMP 102, as illustrated in FIG. 1. The CMP 202 can be implemented on a computer (e.g., a computer 300, such as illustrated in FIG. 3), such as a laptop computer, a desktop computer, a server, a tablet computer, a workstation or the like. The CMP 202 can include memory 204 for storing data and machine-readable instructions. The memory 204 can be implemented, for example, as a non-transitory computer storage medium, such as volatile memory (e.g., random access memory), non-volatile memory (e.g., a hard disk drive, a solid-state drive, flash memory or the like) or a combination thereof.

The CMP 202 can include a processing unit 206 to access the memory 204 and execute the machine-readable instructions stored in the memory 204. The processing unit 206 could be implemented, for example, as one or more processor cores. In the present example, although the components of the processing unit 206 are illustrated as being implemented on the same system, in other examples, the different components could be distributed across different systems and communicate, for example, over a network. Thus, the CMP 202 can be distributed across a plurality of different systems. The CMP 202 can be programmed to facilitate an advertisement campaign (or a marketing campaign).

The CMP 202 can include one or more consumer data provider interface modules 208 (which can be referred to herein “consumer data provider interface modules 208”). Each of the consumer data provider interface modules 208 can be configured to communicate over a network 210 (e.g., such as the network 104, as illustrated in FIG. 1) with an interface of a corresponding consumer data provider (e.g., such as the consumer data provider 106a, 106b, or 106c, as illustrated in FIG. 1). Each of the consumer data providers can be configured to communicate with one another to share related consumer behavior data for an individual consumer. Such sharing can include a cookie sync process to enable respective consumer data providers to identify the consumer behavior data for the individual consumer over respective systems.

The CMP 202 can further include a digital asset management (DAM) platform interface module 212. The DAM platform interface module 212 can be programmed to communicate over the network 210 with an interface of a corresponding DAM platform (e.g., such as the DAM platform 110, as illustrated in FIG. 1). In some examples, the corresponding DAM platform can be part of the CMP 202. The CMP 202 can be configured to communicate with the DAM platform via the DAM platform interface module 212 to retrieve one or more digital advertisement assets and associated metadata for the advertisement campaign.

The CMP 202 can be programmed to receive campaign description data, for example, at an input device 214 of CMP 202, as described herein. The input device can include a keyboard, a mouse, or any device that can receive information from the advertiser. The consumer devices can correspond to the consumer devices 108a-d, such as illustrated in FIG. 1. The CMP 202 can be programmed to communicate the campaign description data to the consumer data providers, for example, via a corresponding consumer data provider interface modules 208. The consumer data providers can be configured to facilitate delivery of advertisement content data to the consumer devices associated with the individual consumer based on the campaign description data for the advertising campaign. For example, the CMP 202 can be programmed to communicate with a plurality of different DSPs, such that advertisers can bid on advertisement inventory associated with a plurality of different publishers over a variety of different SSPs and/or ad exchange servers based on the campaign description data for the advertisement campaign.

The CMP 202 can further be programmed to employ a sync and monitoring engine (SME) module 216. The SME module 216 can be programmed to communicate with each of the consumer data providers via a corresponding interface module 208 and perform a consumer identification sync, such that the individual consumer's behavior can be monitored across each of the consumer data providers. The CMP 202 can be configured monitor the individual consumers behavior across each of the consumer data providers without any information associated with an identity of the user, such as the individual consumer's PII.

The SME module 216 can be programmed to transmit a sync request to each consumer data provider based on consumer data provider (CDP) identifier (ID) data that can include a CDP ID identifying a respective consumer data provider. Each of the consumer data providers can be configured to transmit a confirmation message confirming a participation in the consumer identification sync. The sync and evaluation engine module 216 can be programmed to generate a unique consumer monitoring platform (CMP) ID for each individual consumer. The SME module 216 can further be programmed to transmit the unique CMP ID to each of the consumer data providers in response to receiving the confirmation message. Alternatively, SME module 216 can be configured to transmit the sync request that includes the unique CMP ID. The unique CMP ID can include the CDP ID.

Each of the CDPs can be configured to generate consumer sync data based on unique CMP ID. The consumer sync data can characterize an association between the unique CMP ID and a unique consumer CDP ID for each individual consumer assigned by each consumer data provider. The unique consumer CDP ID can include a WebID, a device ID, or a combination therefor, which can be associated with the consumer behavior data for the individual consumer at a respective consumer data provider. Accordingly, the consumer sync data can characterize the association between the unique CMP ID and the unique consumer CDP ID for each of the consumer data providers. The consumer sync data generated by a respective consumer data provider can include the CDP ID.

Each of the consumer data providers can be configured to transmit respective consumer sync data to the SME module 216. The SME module 216 can further be programmed to associate the unique CMP ID with a unique asset ID related to a digital advertisement asset based on the consumer sync data, such that the unique asset ID is associated with the unique customer CDP ID. The SME module 216 can further be programmed to generate an association table characterizing the association between the unique CMP ID, the unique asset ID and the unique customer CDP ID. The SME module 216 can further be programmed to periodically communicate with each of the consumer data providers to update the association table based on new unique CMP ID data. The SME module 216 can further be programmed to monitor the individual consumer for the behavior data across each of the consumer data providers based on the association table. The consumer data can include behavior information generated in response to digital advertisement assets, as well as non-asset advertisements.

The CMP 202 can further be programmed to employ a page tag module 218. The page tag module 218 can be programmed to generate a CMP page tag for advertisement content data that can be served (e.g., in a corresponding impression opportunity) during the advertising campaign to the consumer devices associated with individual consumer based on the unique CMP ID. A CMP page tag can include a CMP pixel tag or a JavaScript CMP tag. The CMP pixel tag can be represented as a 1×1 uniform resource locator (URL) script: <img src=“https://CMPprogram.io/b?auid={CMP_USER_ID}” width=“1” height=“1” border=“0”/>. The JavaScript CMP tag can be represented as <script type=“text/javascript” src=“https://CMPprogram.io/b?auid={CMP_USER_ID}></script>. JavaScript pixels can correspond to containers that can store and trigger (e.g., fire) multiple image pixels asynchronously (e.g., at the same time). Thus, the CMP tag can include the unique CMP ID. The page tag module 218 can be programmed to generate CMP page tags that can include page tag properties. The one or more page tag properties can include, but not limited to, a unique CMP ID (e.g., “CMP_USER_ID”), a name, description, account, format, delivery method, a create date, and/or a combination thereof.

The CMP 202 can further be programmed to employ an asset tag module 220. The asset tag module 220 can be programmed to generate an asset CMP tag for each digital advertisement asset that can be served (e.g., in a corresponding impression opportunity) during the advertising campaign to the consumer devices based on the unique asset ID. The asset CMP tag can include a CMP asset pixel tag. The CMP asset pixel tag can be represented as <img src=“https://apolloprogram.io/img?trid=64&cb={{CACHEBUSTER}} &assetid={{ASSET_ID}}” height=“1” width=“1” style=“display:none;”>. The CMP asset pixel tag can be associated with each digital advertisement asset. An asset ID macro (“ASSET_ID”) of the asset pixel tag can serve as a link between the consumer data providers and the DAM platform and enable tracking of individual consumers. The individual consumers behavior can be evaluated based on consumer behavior data provided by the one or more consumer data providers and asset data provided by the one or more DAM systems.

A pixel can collect the consumer behavior data including whether a consumer clicked on the advertisement, viewed the advertisement, and/or initiated the advertisement content. The pixel typically contains a number of items of the consumer behavior data relating to how a consumer interacted with the advertising content and/or asset advertisement. The items of the consumer behavior data can be returned to the SSP and/or the DSP in order to provide feedback on the circumstances of delivery of the advertisement. For example, the items of consumer behavior data can include a datum relating to whether a user clicked on a video, watched the video to a particular video frame (or point in time), or the like. Certain items of the behavior data can correspond to events that are referred to as “beacon” events as a result of their salience to the advertiser. For example, a beacon event can include a fact that the individual consumer stopped a video segment before it completed.

The SME module 216 can further be programmed to transmit CMP tag and/or the asset CMP tag with (or part of) the campaign description data to the consumer data providers 106a-c. Alternatively, the SME module 216 can be configured to transmit the CMP page tag and/or the CMP asset tag (directly or indirectly) at a later time relative to a time that the campaign description data was transmitted, and/or in response to a tag request(s) provided by (or on behalf of) the consumer data providers based on data received at a publishing platform (e.g., such as the publishing platform 112, as illustrated in FIG. 1). The data can be generated at the consumer devices 108a-d. Each of the asset CMP tags and the CMP page tags can be transmitted to a corresponding CDP. Each CDP can facilitate serving of the digital advertisement asset and the impression opportunity, such that during the serving, the CMP page tag is served with the advertisement content data and the asset tag is served with the digital advertisement asset, to each of the consumer devices associated with the individual consumer.

The CDP tag can notify each of the consumer data providers 106a-c and generate a CDP cookie based on information provided by the consumer data providers 106a-c. The CDP cookie can include data identifying the individual consumer, such as the unique consumer CDP ID, and the consumer behavior data characterizing the individual consumer behaviors associated with the one or more impression opportunities. The CDP cookie can be stored locally on the consumer devices 108a-d. The CDP cookie ID can include the unique consumer CDP ID. In another example, the CDP tag can generate a CDP cookie ID identifying the individual consumer and cause the consumer behavior data to be transmitted to the consumer data providers 106a-c for storage in an associated behavior database. In an example, the consumer data providers 106a-c can generate the CDP cookie ID and place the cookie ID on the one or more consumer devices 108a-d in response to the CDP tag. If the individual consumer does not have an assigned unique consumer CDP ID, the consumer data providers 106a-c can be configured to assign a unique consumer CDP ID to the individual consumer and transmit the CDP cookie ID to the consumer devices 108a-d.

The CMP page tag can notify the CMP 102 and pass the unique CMP ID associated with the impression opportunity to the CMP 102. That is, the sync and evaluation engine module 216 can be configured to receive a tag notification comprising the unique CMP ID in response to the serving of the CMP page tag. The sync and evaluation engine module 216 can be configured to evaluate the unique CMP ID of the tag notification relative to the association table to determine the unique customer CDP ID for the individual consumer for each CDP served the advertisement during the advertising campaign. The CMP asset tag can notify the CMP 102 and pass the unique asset ID associated with digital advertisement asset to the CMP 102. That is, the SME module 216 can be programmed to receive an asset notification comprising the unique asset ID in response to the serving of the CMP asset tag. The SME module 216 can further be programmed to evaluate the unique asset ID of the asset notification relative to the association table to determine the unique customer CDP ID for the individual consumer for each CDP served the advertisement during the advertising campaign.

The SME module 216 can further be programmed to communicate a consumer data request for the individual consumer to the consumer data providers based on the evaluation. The consumer data request can include customer CDP ID. The consumer data providers can be configured to in response to the consumer data request transmit the consumer behavior data and the consumer asset data for the individual consumer. The consumer asset data can include metadata for the served digital advertisement asset. Alternatively, the SME module 216 can further be configured to communicate to the DAM to receive the metadata for the served asset based on the evaluation.

The CMP 202 can further include an evaluation engine module 222. The evaluation engine module 222 can be programmed to evaluate the consumer behavior data and/or the consumer asset for the individual consumer. The evaluation can include apply marketing analytics, insights into consumer trends, solutions for business problems, recommendations for business growth opportunities. Some examples where these can apply, include, but not limited to, retail services, financial services, public service, healthcare, and other areas that can fall outside of the advertising industry. The evaluation engine module 222 can be programmed to adjust parameters of the advertisement campaign based on a result of the evaluation to adjust advertisements delivered to the individual in the future such that more relevant (or more personal advertisements) can be delivered to the individual consumer.

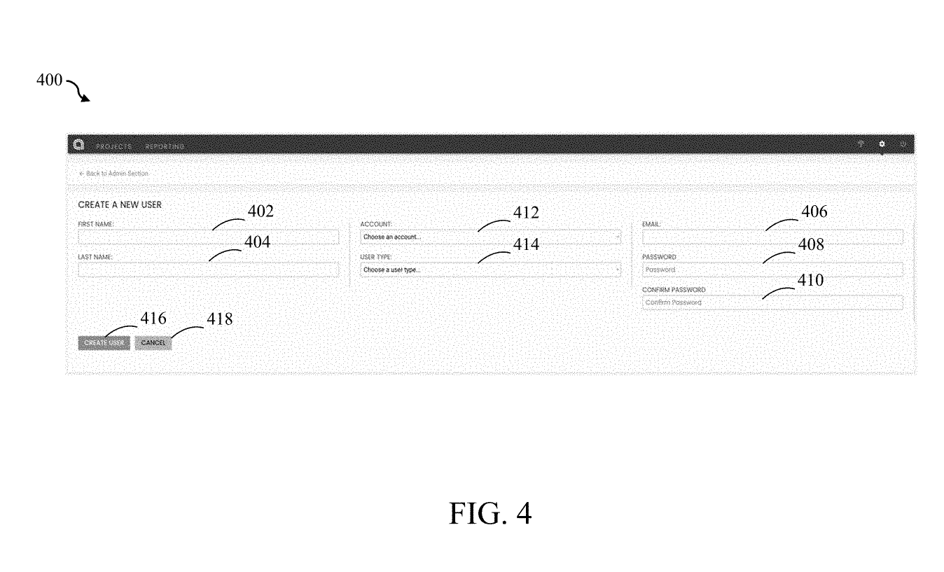

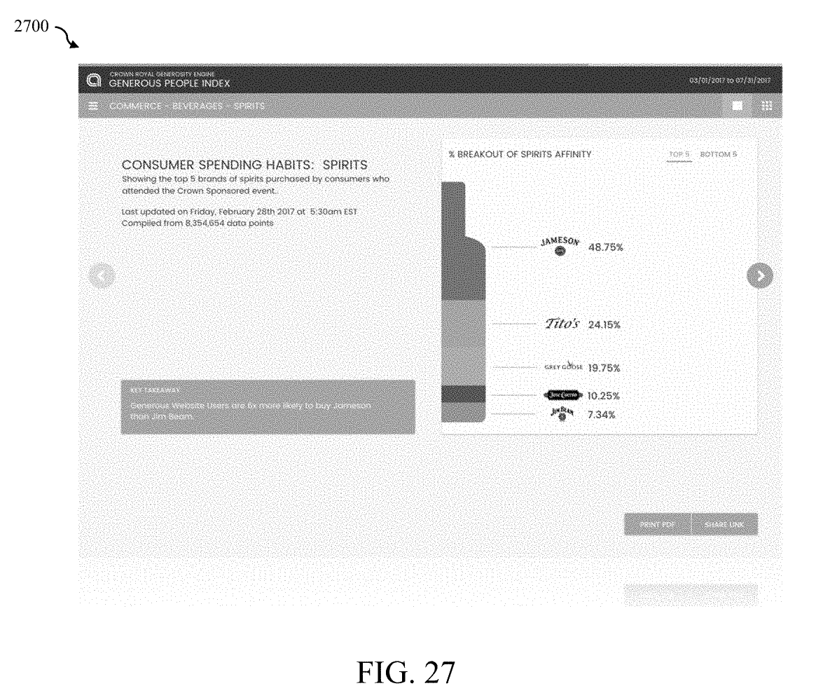

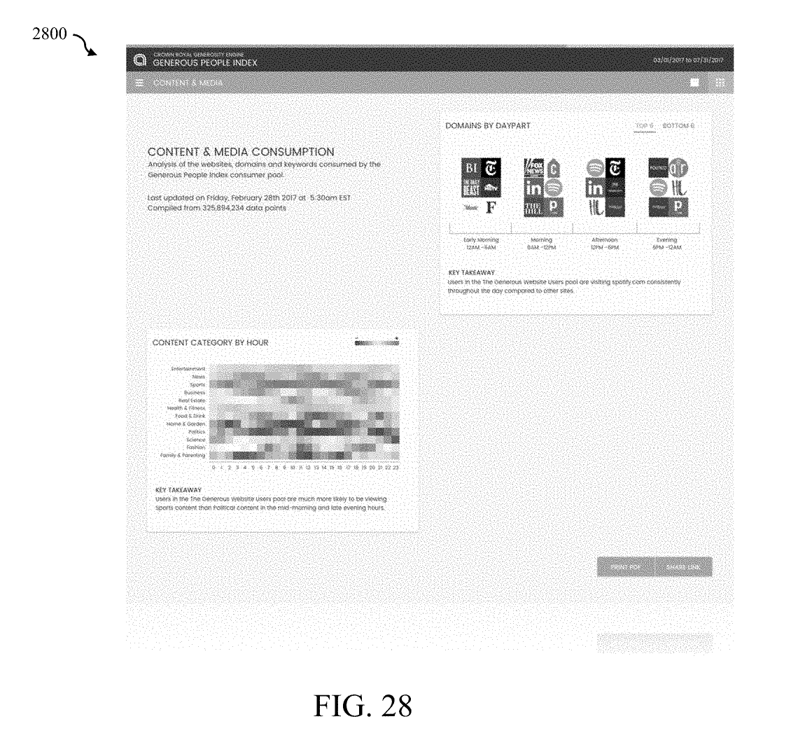

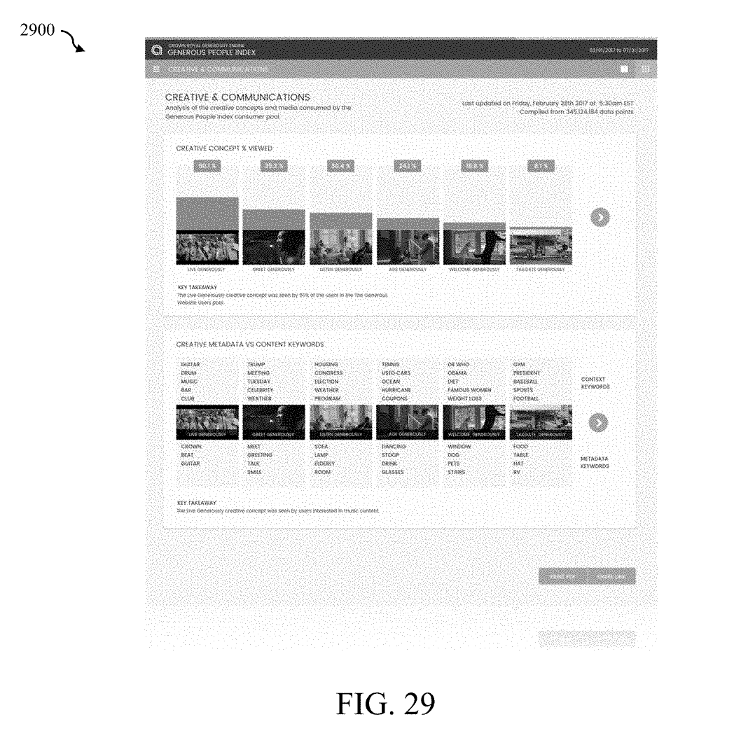

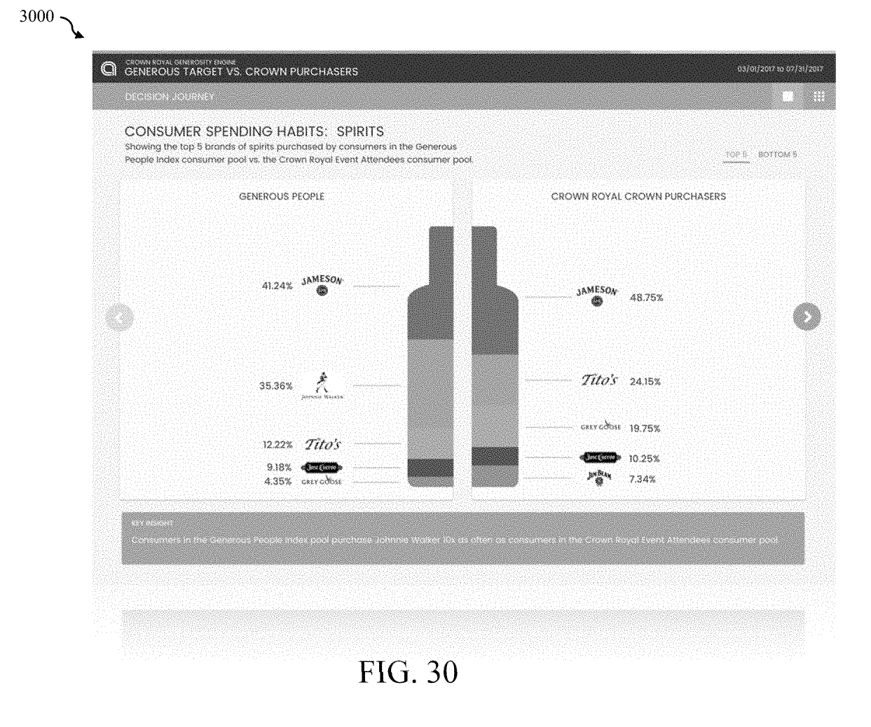

The CMP 202 can further be programmed to employ a graphical user interface (GUI) module 224. The GUI module 224 can be programmed to communicate GUI data to a display generator module 226 based on stored GUI data in the memory 204. The GUI module 224 can be programmed to generate the stored GUI data based data described herein. The display generator module 222 can be programmed based on the GUI data to generate one or more GUIs that can include one or more graphical elements, such as illustrated in FIGS. 4-30. The one or more generated GUI's can be visualized on a display 228, which can interface with the display generator module 226. The user can interact with the one or more graphical elements of the one or more generated GUIs. For example, the user can interact with the one or more graphical elements via a user input device (e.g., a mouse, keyboard, touch screen or the like), such as the input device 214. The one or more graphical elements can include a selection element, such as a cursor, that the user can position with a pointing device (e.g., a mouse, touch screen and the like) to interact with one or more other graphical elements of the one or more generated GUIs. In some examples, the graphical elements can include, but not limited to, graphical buttons, tabs, text field and input fields. In a further example, the CMP 202 can include a web scraper module 230. The web scraper module 230 can be programmed to associate the unique CMP ID to content of a webpage of a URL visited by the individual consumer in form of keywords and imagery. The unique CMP ID can be associated with URL of the webpage (or page URL). Thus, the unique CMP ID can be associated with the unique CDP ID and the unique asset ID. The URL provided can be based on webpages that an advertiser can provide (e.g., their own webpage or other webpages where their advertisement content can appear), or webpages that the individual consumer otherwise can read and/or visit.

The web scraper module 230 can be programmed to evaluate content of each webpage provided to the individual consumer. The content can include, a text, an image, and a combination thereof. In some examples, the web scraper module 230 can be programmed to scan each webpage for a particular text and/or image. The web scraper module can further be programmed to translate text of the webpage to English (e.g., if the webpage is another language). The web scraper module 230 can further be programmed to send a page text summary to a summary API (not shown in FIG. 2). The summary API can be programmed to provide keywords for each webpage. The web scraper module 230 can further be programmed to receive keyword data characterizing keywords for each webpage. The web scraper module 230 can be programmed to assign a strength score to each of the keywords for each webpage.

The web scraper module 230 can further be programmed to exclude images and/or videos greater than a certain size (e.g., in order to try to eliminate images that correspond to text or cascading style sheet (CSS) elements). The web scraper module 230 can be programmed to cause each image and/or video to be downloaded to an s3 bucket, and the downloaded path can be stored in the memory 204. For every downloaded image and video, the image and/or video can be sent to the DAM where image recognition engine scans the assets, to provide descriptive words (e.g., metadata). The metadata and assets can then be stored in memory of an associated DAM platform. By scanning the images, relevant keywords can be generated, thereby allowing for contextual connections to be made between content, images, and the individual consumers.

In view of the foregoing structural and functional description, those skilled in the art will appreciate that portions of the examples described herein may be embodied as a method, processing system, or computer program product. Accordingly, the examples described herein may take the form of an entirely hardware, an entirely software, or combination of software and hardware, such as shown and described with respect to the computer system 300 of FIG. 3. Furthermore, portions of the examples described herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Moreover, certain examples described herein have also been referred herein with regards to block illustrations of methods, systems, and computer program products. It will be understood that blocks of the illustrations, and combinations of blocks in the illustrations, can be implemented by computer-executable instructions. These computer-executable instructions may be provided to one or more processors of a general-purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In this regard, FIG. 3 illustrates an example of a computer system 300 that can be employed to execute one or more examples described herein, such as including acquisition, receiving, processing, evaluation and/or analysis of consumer and asset data, as well other data. Computer system 300 can be implemented on one or more purpose networked computer systems, embedded computer systems, routers, switches, server devices, client devices, various intermediate devices/nodes or standalone computer systems. Additionally, computer system 300 can be implemented on various mobile clients such as, for example, a personal digital assistant (PDA), laptop computer, pager, and the like, provided it includes sufficient processing capabilities.

Computer system 300 can include processing unit 301, system memory 302, and system bus 303 that can couple various system components, including the system memory 302, to processing unit 301. Dual microprocessors and other multi-processor architectures also can be used as processing unit 301. System bus 303 may be any of several types of bus structure including a memory bus or memory controller, a peripheral bus, and a local bus using any of a variety of bus architectures. System memory 302 can include read only memory (ROM) 304 and random-access memory (RAM) 305. A basic input/output system (BIOS) 306 can reside in ROM 304 containing the basic routines that help to transfer information among elements within computer system 300.

Computer system 300 can further include a hard disk drive 307, magnetic disk drive 308, e.g., to read from or write to removable disk 309, and an optical disk drive 310, e.g., for reading CD-ROM disk 311 or to read from or write to other optical media. Hard disk drive 307, magnetic disk drive 308, and optical disk drive 310 can be connected to system bus 303 by a hard disk drive interface 312, a magnetic disk drive interface 313, and an optical drive interface 314, respectively. The drives and their associated computer-readable media provide nonvolatile storage of data, data structures, and computer-executable instructions for computer system 300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of the disclosure described herein.

A number of program modules can be stored in drives and RAM 305, including operating system 315, one or more application programs 316, other program modules 317, and program data 318. The one or more program modules can include a consumer data provider interface module (e.g., such as the consumer data provider interface module 208, as illustrated in FIG. 2), a digital asset management platform (DAM) interface module (e.g., such as the DAM interface module 212, as illustrated in FIG. 2), a sync and evaluation engine module (e.g. such as the sync and evaluation engine module 216, as illustrated in FIG. 2), a page tag module (e.g. such as the page tag module 218, as illustrated in FIG. 2), an asset tag module (e.g. such as the asset tag module 220, as illustrated in FIG. 2), an evaluation engine module (e.g. such as the evaluation engine module 222, as illustrated in FIG. 2), a graphical user interface module (e.g. such as the graphical user interface module 224, as illustrated in FIG. 2) and a display generator module (e.g. such as the display generator module 226, as illustrated in FIG. 2). The application programs and program data can include functions and methods programmed to receive and process data related to a plurality of individual consumers a cross plurality of consumer data provider (e.g., such as the consumer data providers 106a-c, as illustrated in FIG. 1).

A user may enter commands and information into computer system 300 through one or more input devices 320, such as a pointing device (e.g., a mouse, touch screen), keyboard, microphone, joystick, game pad, scanner, and the like. In an example, the one or more input devices 320 can correspond to the input device 214, such as illustrated in FIG. 2. For instance, the user can employ input device 320 to control one or more features of the system described herein. These and other input devices 320 are often connected to processing unit 301 through a corresponding port interface 322 that is coupled to the system bus, but may be connected by other interfaces, such as a parallel port, serial port, or universal serial bus (USB). One or more output devices 324 (e.g., display, a monitor, printer, projector, or other type of displaying device) can also be connected to system bus 303 via interface 326, such as a video adapter.

Computer system 300 may operate in a networked environment using logical connections to one or more remote computers, such as remote computer 328. Remote computer 328 may be a workstation, computer system, router, peer device, or other common network node, and typically includes many or all the elements described relative to computer system 300. The logical connections, schematically indicated at 330, can include a local area network (LAN) and a wide area network (WAN). When used in a LAN networking environment, computer system 300 can be connected to the local network through a network interface or adapter 332. When used in a WAN networking environment, computer system 300 can include a modem, or can be connected to a communications server on the LAN. The modem, which may be internal or external, can be connected to system bus 303 via an appropriate port interface. In a networked environment, application programs 316 or program data 318 depicted relative to computer system 300, or portions thereof, may be stored in a remote memory storage device 340.

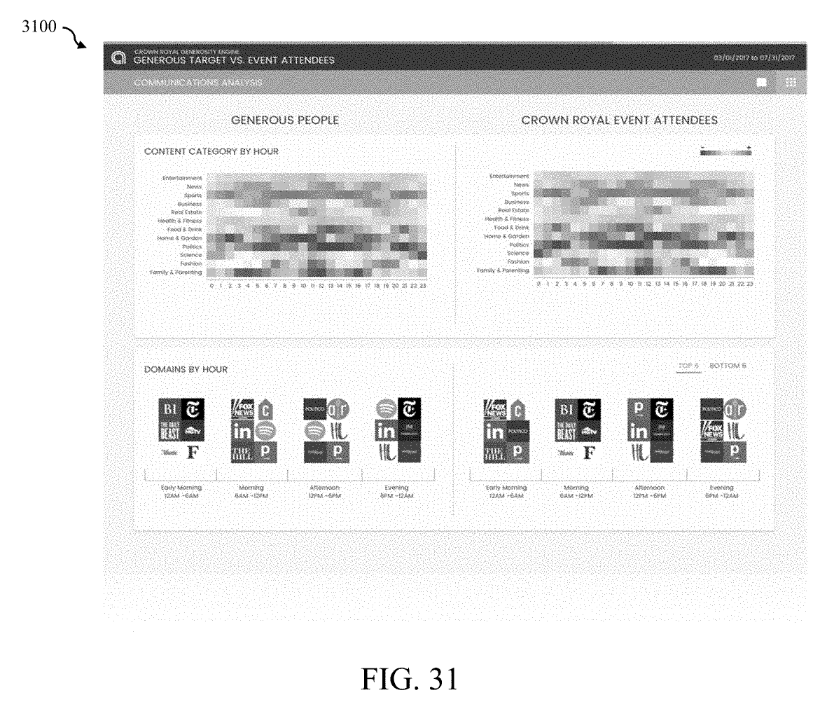

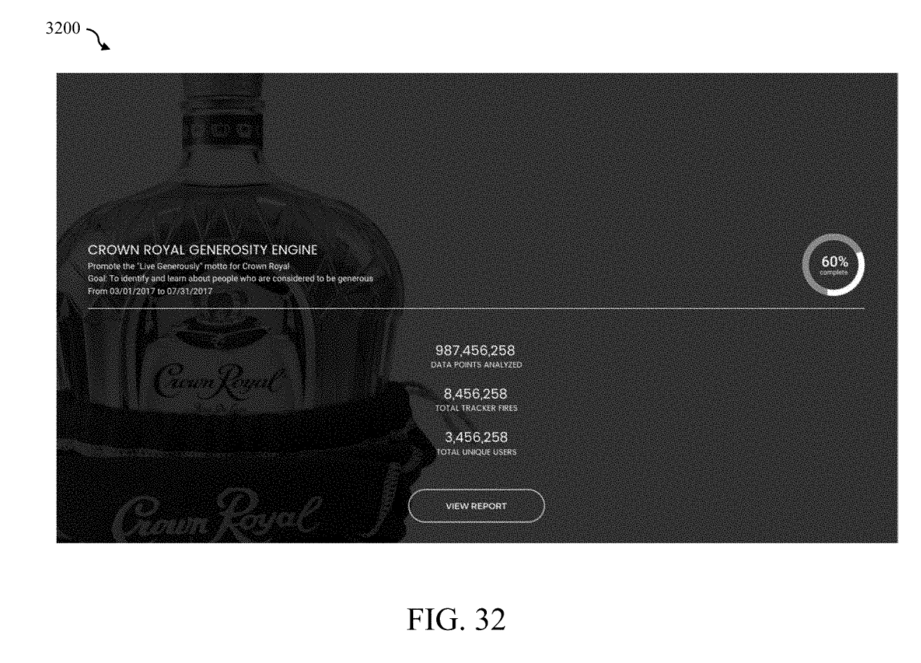

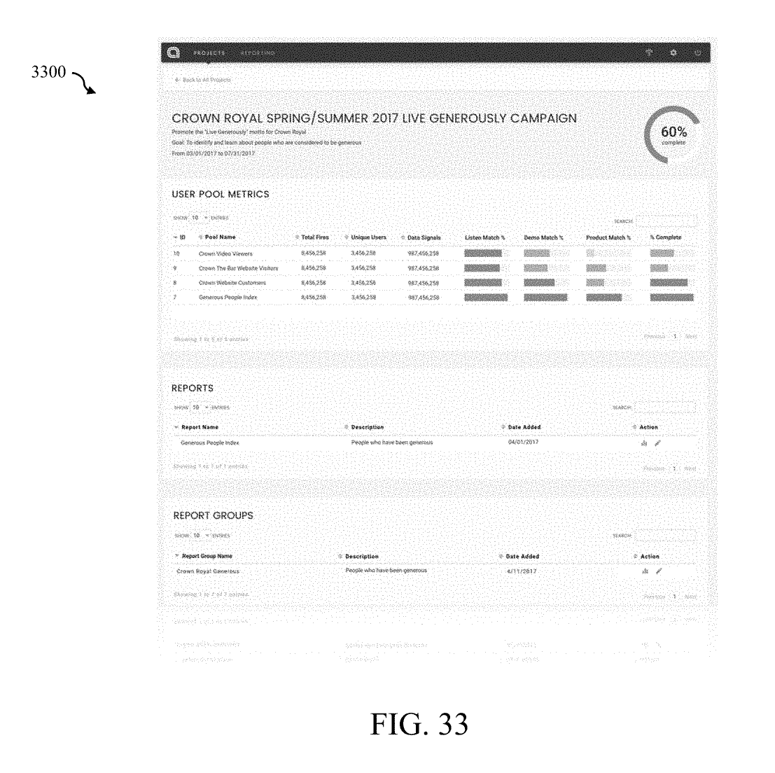

FIGS. 4-33 illustrate a plurality of GUI that can generated by a display generator module (e.g., such as the display generator module 226, as illustrated in FIG. 2) and visualized on a display (e.g., such as the display 226, as illustrated in FIG. 2). The display generator module can be part of a consumer monitoring platform (CMP) (e.g., such as the CMP 102, as illustrated in FIG. 1 or the CMP 202, as illustrated in FIG. 2). Accordingly, each of the GUI described herein can be generated by the CMP.

FIG. 4 illustrates a registration GUI 400. The registration GUI 400 can be utilized by a user, such an advertiser or marketer, to register the user with the CMP. The registration GUI 400 can include a first name entry element 402, a surname name entry element 404, an email entry element 406, a password entry element 408 and a confirm password entry element 410. The user can interact with the registration GUI 400 via the user input device to input appropriate information into the entry input elements of the registration GUI 400. The registration GUI 400 can further include an account drop-down element 412. The account drop-down element 412 can be activated by the user to provide a list of accounts. The user can select a given account from the list of the accounts. The registration GUI 400 can further include a user type drop-down element 414. The user type drop-down element 414 can be activated by the user to provide a list of user types. The list of user types can include, but not limited to, an administrator type and a user type. The user can select a given user type from the list of user types. The registration GUI 400 can further include a create user interface element 416 and cancel interface element 418. The user can activate the create user interface element 416 to confirm a creation of the user or the cancel interface element 418 to cancel the creation of the user. In response to the user activating the create user interface element 416, the system 202 can be configured to save the inputted information in memory of the CMP as user registration data (e.g., the memory of the CMP 102, as shown in FIG. 1 or the memory 204 of the CMP 202, as shown in FIG. 2).

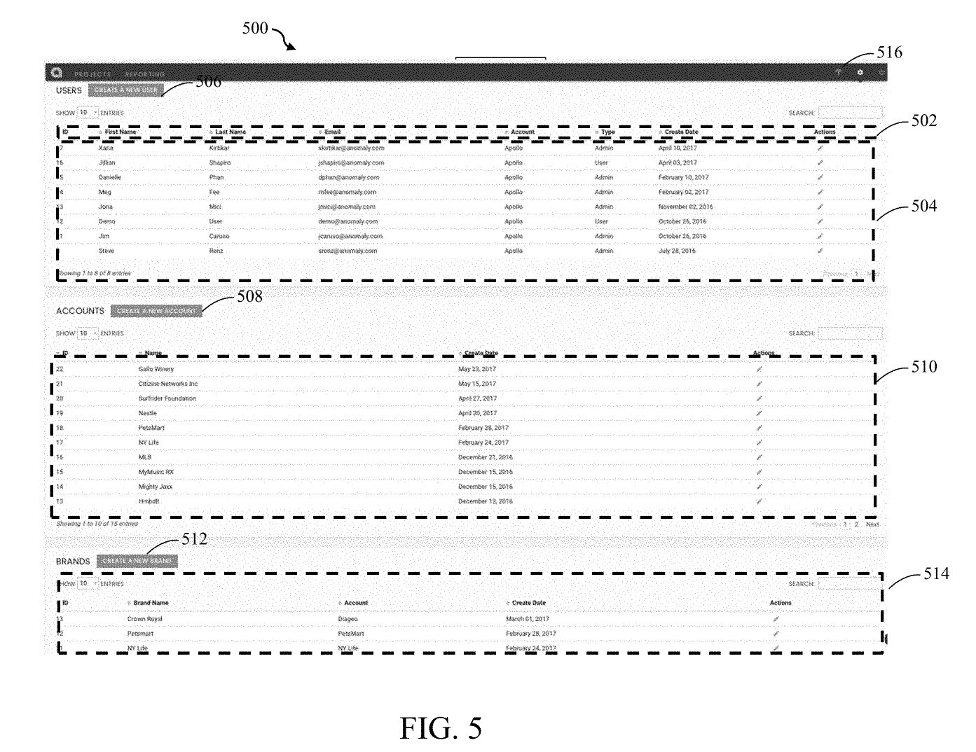

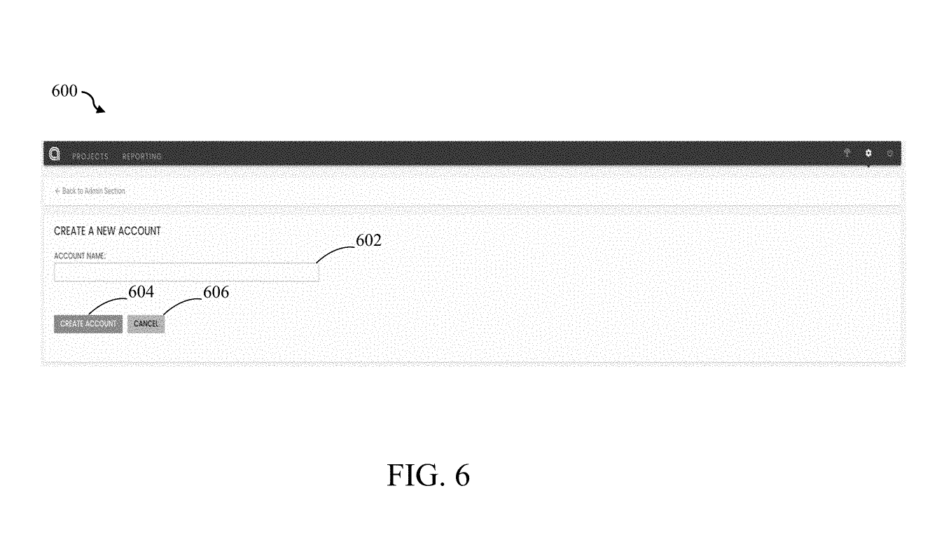

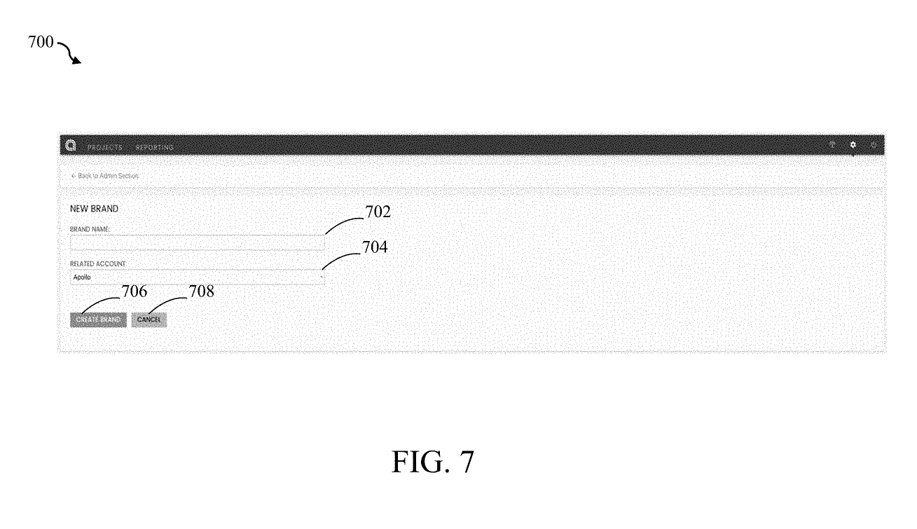

The display generator module 210 can further be programmed to generate an administration GUI 500, such as illustrated in FIG. 5. The administration GUI 500 can include a plurality of header text elements 502 and a plurality of user elements 504. In some examples, the plurality of header text elements 502 can include an ID, a first name, a last name, an email, an account, a type, a created date and an action. The administration GUI 500 can further include a create a new user interface element 506. The user can activate the create a new user interface element 506 to cause the display generator module to generate the registration GUI 400, such as illustrated in FIG. 4. The administration GUI 500 can further include a create a new account interface element 508. The user can activate the create a new account interface element 508 to cause the display generator module to generate a create a new account GUI 600 on the display 210, such as illustrated in FIG. 6. The administration GUI 500 can further include a plurality of created accounts 510 associated with the CMP, which can be created using the create a new account GUI 600, as illustrated in FIG. 6. The administration GUI can further include a create a new brand interface element 512. The user can activate the create a new brand interface element 512 to cause the display generator module to generate a create a new brand interface element to generate create a new brand GUI 700 on the display 210, such as illustrated in FIG. 7. The administration GUI 500 can further include a plurality of created brands 514 each of which can be associated with brand name data, account name data and additional information, such as a creation date. The plurality of created brand names can be stored part of the campaign description data, as described herein.

The create a new account GUI 600 can include an account name entry element 602. The user can input account information (e.g., “Diageo”) into the account name entry element 602. The create a new account GUI 600 can further include a create account interface element 604 and cancel interface element 606. The user can activate the create account interface element 604 to confirm a creation of the account or the cancel interface element 606 to cancel the creation of the account. The system 202 can be configured to save the inputted account name information in the memory 204 as the account name data in response to the user activating the create account interface element 604.

The display generator module 210 can further be programmed to generate the administration GUI 500 in response to the user activating the create account interface element 604 of the create a new account GUI 600 on the display 210. As mentioned, the user can activate the create new brand interface element 510 to cause the display generator module 210 to generate the create a new brand GUI 700 on the display 210, such as illustrated in FIG. 7.

The create a new brand name GUI 700 can include a brand name entry element 702. The user can input brand name information (e.g., “Crown Royal”) into the brand name entry element 702. The create a new brand name GUI 700 can further include a related account drop-down element 704. The related account drop-down element 704 can be activated by the user to provide a list of related accounts. The user can select a given related account from the list of related accounts. The create a new brand name GUI 700 can further include a create brand interface element 706 and cancel interface element 708. The user can activate the create brand interface element 706 to confirm a creation of the account or the cancel interface element 708 to cancel the creation of the brand name. The system 202 can be configured to save the inputted brand name information and the selected given related account in the memory 204 as the brand name data in response to the user activating the create brand interface element 706.

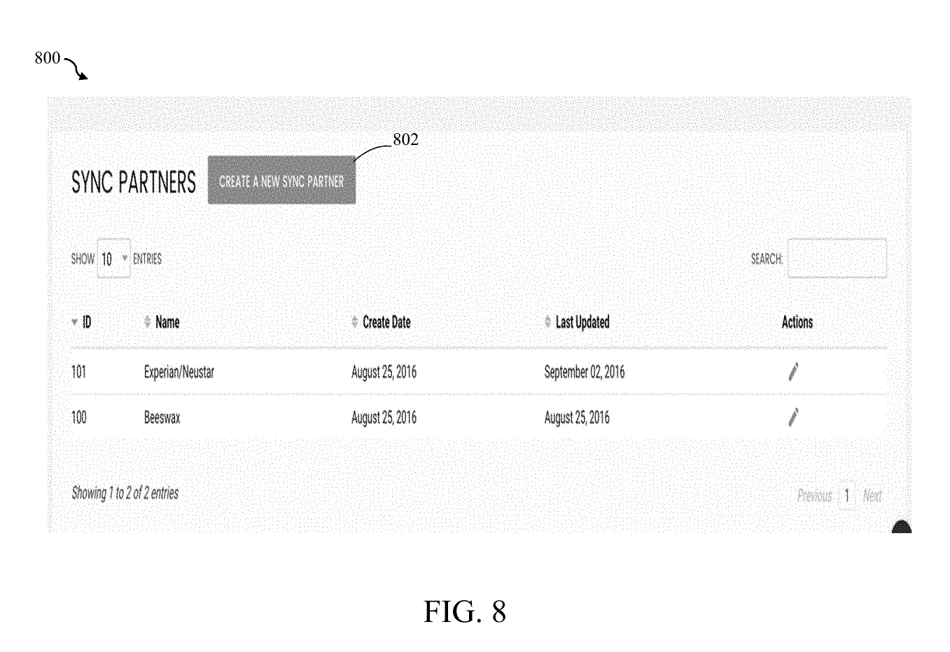

The display generator module 210 can further be programmed to generate the administration GUI 500, for example, in response to the user activating the create brand interface element 706 of the create a new brand name GUI 700 on the display 210. The administration GUI 500 can further include a pixel interface element 516. The user can activate the create pixel interface element 512 to cause the display generator module 210 to generate a pixel GUI 800 on the display 210, such as illustrated in FIG. 8. The user can interact with the one or more graphical elements of the pixel GUI 800 to define a pixel according to systems and methods described herein.

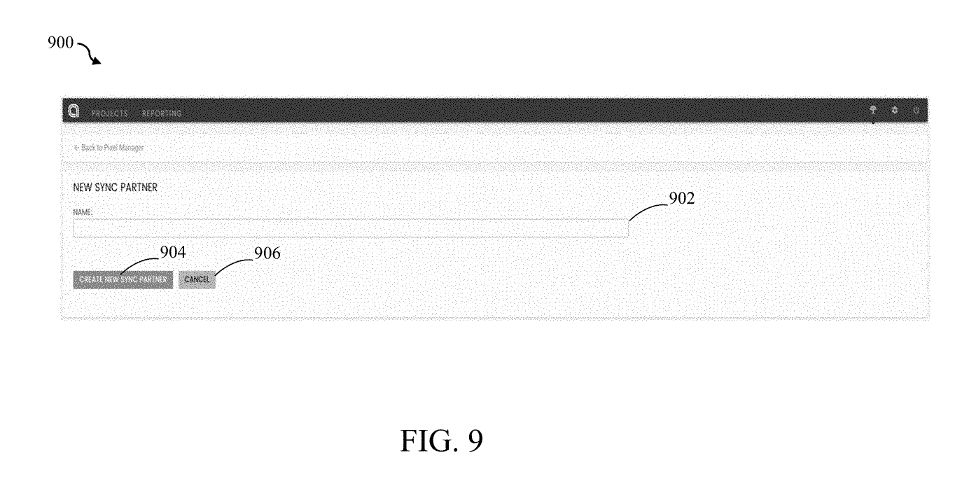

The pixel GUI 800 can include a create a new sync partner interface element 802. The user can activate the create a new sync partner interface element 802 to cause the display generator module 210 to generate a create a new sync partner GUI 900, such as illustrated in FIG. 9. The create a new sync partner GUI 900 can include a sync partner name input element 902. The user can input sync partner name information (e.g., “Beeswax”) into the sync partner input element 902. The inputted partner name information can correspond to an identifier of a corresponding consumer data provider (CDM) (e.g., a given consumer data provider, as illustrated in FIG. 1). The create a new sync partner GUI 900 can further include a create new sync partner interface element 904 and cancel interface element 906. The user can activate the create new sync partner interface element 904 to confirm a creation of a new sync partner or the cancel interface element 906 to cancel the creation of the new sync partner. The system 202 can be configured to save the inputted sync partner name information in the memory 204 as sync partner name data in response to the user activating the create new sync partner interface element 904. The sync partner name data can be associated with corresponding sync data generated by the CMP.

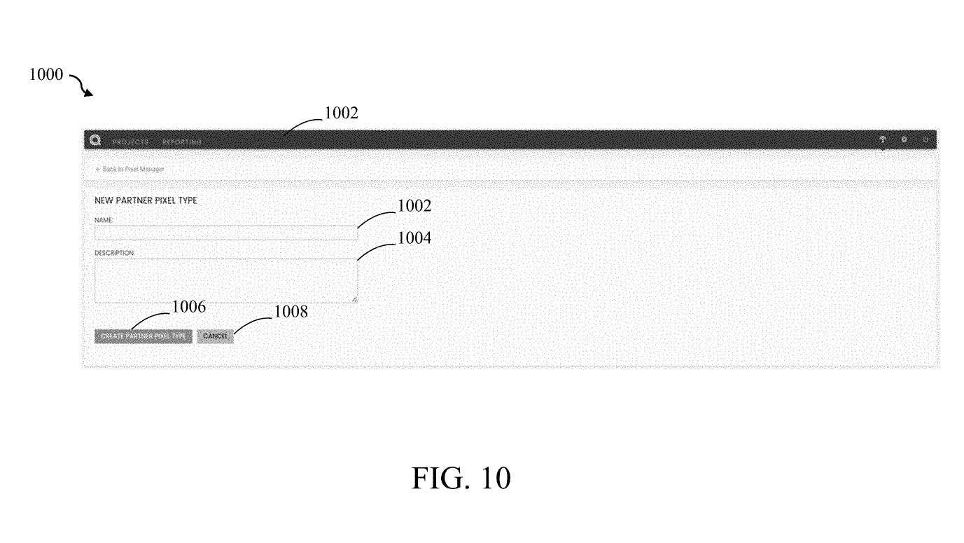

The display generator module can further be programmed to generate a create a new partner pixel type GUI 1000, such as illustrated in FIG. 10, for example, based on user input. The create a new partner pixel type GUI 1000 can include a pixel type entry element 1002. The user can input pixel type information (e.g., “Return Redirect”) into the pixel type entry element 1002. The create a new partner pixel type GUI 1000 can further include a pixel type description entry element 1004. The user can input pixel description information (e.g., “fire CMP ID to partner; the partner sends back the CMP ID and an unique partner ID”) into the pixel type description entry element 1004. The create new partner pixel type GUI 1000 can further include a create partner pixel type interface element 1006 and cancel interface element 1008. The user can activate the create partner pixel type interface element 1006 to confirm a creation of a new partner pixel type or the cancel interface element 1008 to cancel the creation of the new partner pixel type. The CMP can be configured to save the inputted input pixel type information and pixel description information in the memory as pixel type and description data in response to the user activating the create partner pixel type interface element 1006. The pixel type and description data can be used by one or more modules of the CMP.

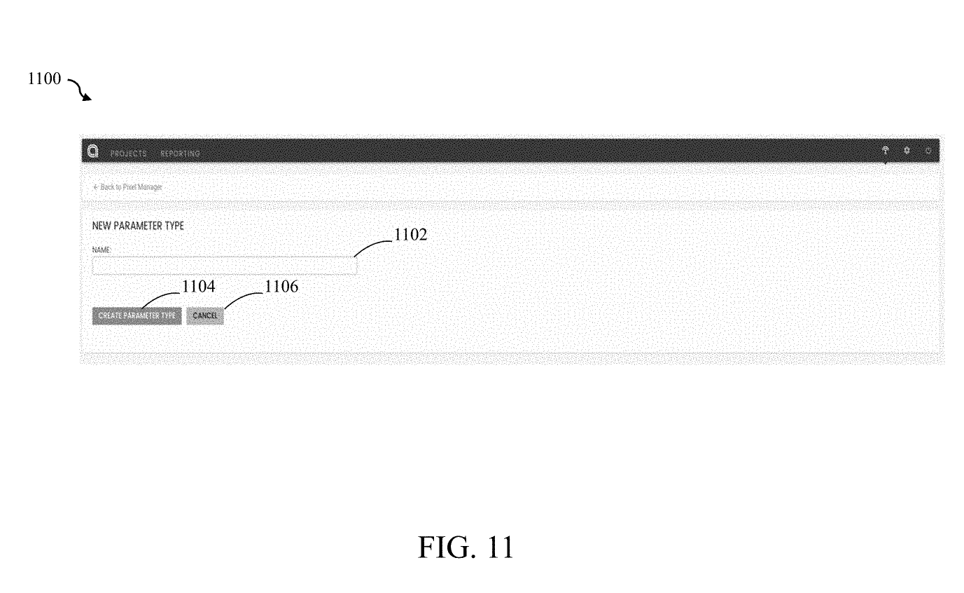

The display generator module can further be programmed to generate a create a new parameter type GUI 1100, such as illustrated in FIG. 11, for example, based on user input at the CMP. The create a new parameter type GUI 1100 can include a parameter type name input element 1102. The user can input parameter type name information (e.g., “Reserve”) into the parameter type input element 1102. The create a new parameter type GUI 1100 can further include a create parameter type interface element 104 and cancel interface element 1106. The user can activate the create parameter type interface element 1104 to confirm a creation of the parameter type or the cancel interface element 1106 to cancel the creation of the parameter type. The CMP can be configured to save the inputted parameter type name information in the memory as parameter type data in response to the user activating the create parameter type interface element 1104. The parameter type data can be used by one or more modules of the CMP.

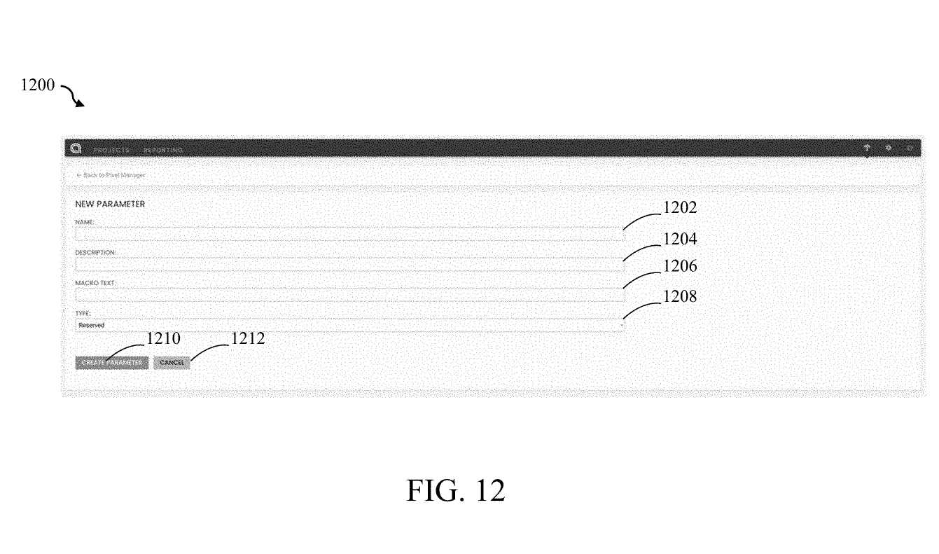

The display generator module can further be programmed to generate a create a new parameter GUI 1200, such as illustrated in FIG. 12, for example, in response to user input. The create a new parameter GUI 1200 can include a parameter name input element 1202. The user input parameter name information (e.g., “prev”) into the parameter name input element 1202. The create a new parameter GUI 1200 can further include a parameter description input element 1204. The user can input parameter description information (e.g., “Product price/revenue”) into the parameter description input element 1204. The create a new parameter GUI 1200 can further include a macro text input element 1206. The user can input macro text information (e.g., “REVENUE”) into the macro text input element 1206. The input macro text information can be embedded in a pixel macro and can define a type of data (e.g., consumer behavior data) that can be monitored.

The create new parameter GUI 1200 can further include a parameter type drop-down element 1208. The parameter type drop-down element 1208 can be activated by the user to provide a list of parameter types. In some examples, a portion of the list of parameter types can be defined by the user. For instance, the list of parameter types can include the parameter type information (e.g., “Reserve”) inputted at the parameter type input element 1202 of the create a new parameter type GUI 1200, such as illustrated in FIG. 12. Thus, the user can select a given parameter type from the list of parameter types. The create new parameter GUI 1200 can further include a create parameter interface element 1210 and cancel interface element 1212. The user can activate the create parameter interface element 1210 to confirm a creation of the parameter or the cancel interface element 1212 to cancel the creation of the parameter. The CMP can be configured to save the inputted parameter name information, the parameter description information, the macro text information and the selected parameter type from the list of parameter types in the memory as parameter data in response to the user activating the create parameter interface element 1210. The parameter data can be used by one or more modules of the CMP.

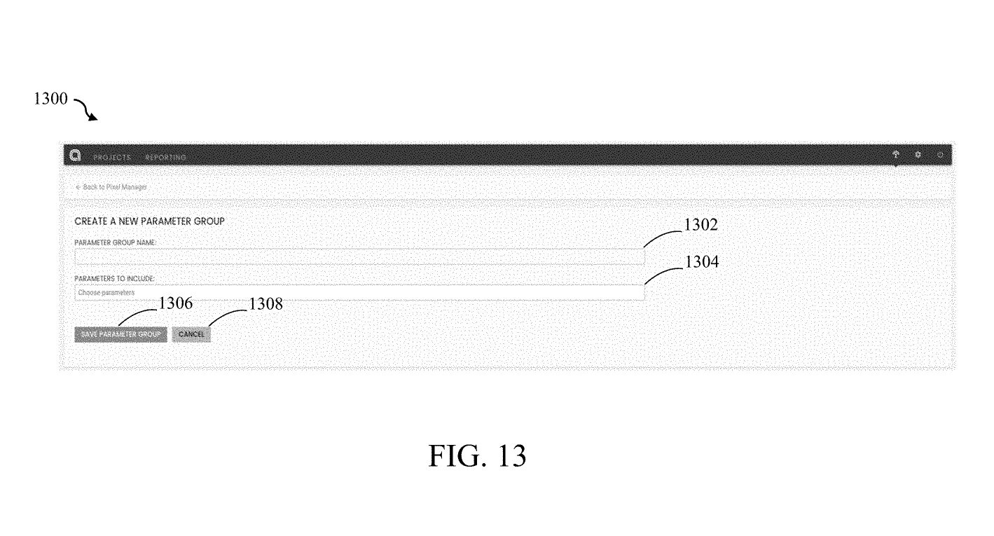

The display generator module can further be programmed to generate a create a new parameter group GUI 1300, such as illustrated in FIG. 13, for example, in response to user input. The create new parameter group GUI 1300 can include a parameter group name input element 1302. The user can input parameter group name information (e.g., “Basic e-commerce (sales data)”) into the parameter group name input element 1302. The create a new parameter group GUI 1300 can further include a parameter group inclusion element 1304. The parameter group inclusion element 1304 can population parameter information (e.g., “page, pnme, prev”) in response to the user placing a cursor over the parameter group inclusion element 1304. The create a new parameter group GUI 1300 can further include a save parameter group interface element 1306 and a cancel interface element 1308. The user can activate the save parameter group interface element 1306 to save the created parameter group or the cancel interface element 1308 to not save the created parameter group. The CMP can be configured to save the parameter group name information and the populated parameter information in the memory as parameter group data in response to the user activating the save parameter group interface element 1306. The parameter group data can be used by one or more modules of the CMP.

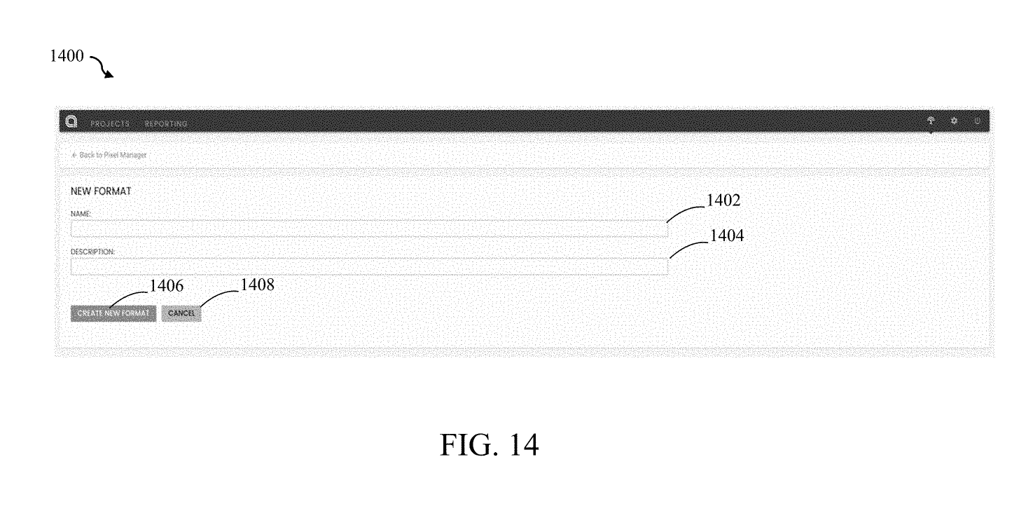

The display generator module can further be programmed to generate a create a new format GUI 1400, such as illustrated in FIG. 14, for example, in response to the user input. The create a new format GUI 1400 can include a format name input element 1402. The user can input format name information (e.g., “Website”) into the format name input element 1402. The create a new format GUI 1400 can further include a format description input element 1404. The user can input format description information (e.g., “Direct pixel placement on a website”) into the format description input element 1404. The create a new format GUI 1400 can further include a create new format interface element 1406 and a cancel interface element 1408. The user can activate the create new format interface element 1406 to save the new format or the cancel interface element 1408 to not save the created new format. The CMP can be configured to save the inputted format name information and the format description information in the memory as format data in response to the user activating the create new format interface element 1406. The format data can be used by one or more modules of the CMP.

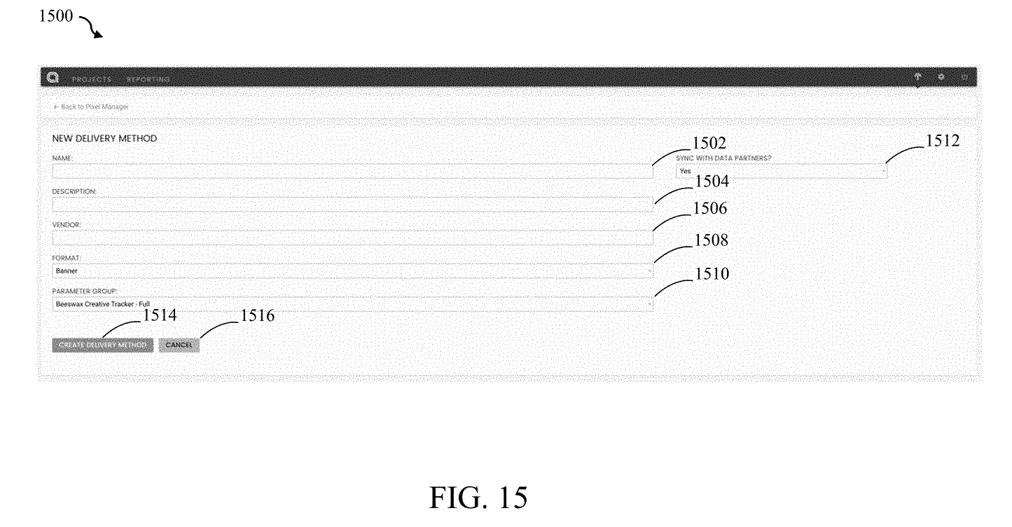

The display generator module can further be programmed to generate a create a new delivery method GUI 1500, such as illustrated in FIG. 15, for example, in response to the user input. The create a new delivery method GUI 1500 can include a delivery method name input element 1502. The user can input delivery method name information (e.g., “Basic E-commerce website”) into the delivery method name input element 1502. The create a new delivery method GUI 1500 can further include a delivery method description input element 1504. The user can input delivery method description information (e.g., “For tracking product, pages visits and sales”) into the delivery method description input element 1504. The create a new delivery method GUI 1500 can further include a vendor name input element 1506. The user can input vendor name information (e.g., “Website”) into the vendor name input element 1506. The vendor name information can be associated with an advertisement serving third-party (e.g., DoubleClick Campaign Manager (DCM)).

The create a new delivery method GUI 1500 can further include a format drop-down element 1510. The format drop-down element 1510 can be activated by the user to provide a list of formats. In some examples, a portion of the list of formats can be defined by the user. Thus, the user can select a given format from the list of formats. The create a new delivery method GUI 1500 can further include a parameter group drop-down element 1510. The parameter group drop-down element 1510 can be activated by the user to provide a list of parameter groups. In some examples, a portion of the list of parameter groups can be defined by the user. For instance, the list of parameter groups can include the parameter group information (e.g., “Basic e-commerce (sales data)”) inputted at the parameter group input element 1302 of the create new parameter group GUI 1300, such as illustrated in FIG. 13. Thus, the user can select a given parameter group from the list of parameter groups. The create a new delivery method GUI 1500 can further include a sync drop-down element 1512. The sync drop-down element can include a plurality of selections, including “Yes” or “No”. The user can identify a given selection for syncing with a corresponding consumer data provider.

The create a new delivery method GUI 1500 can further include a create delivery method interface element 1514 and a cancel interface element 1516. The user can activate the create delivery method interface element 1514 to save the new delivery method or the cancel interface element 1516 to not save the new delivery method. The CMP can be configured to save the inputted method name information, the delivery method description information, the selected given format, the selected given parameter group and the identified given selection in the memory as delivery method data in response to the user activating the create delivery method interface element 1514. The delivery method data can be used by one or more modules of the CMP.

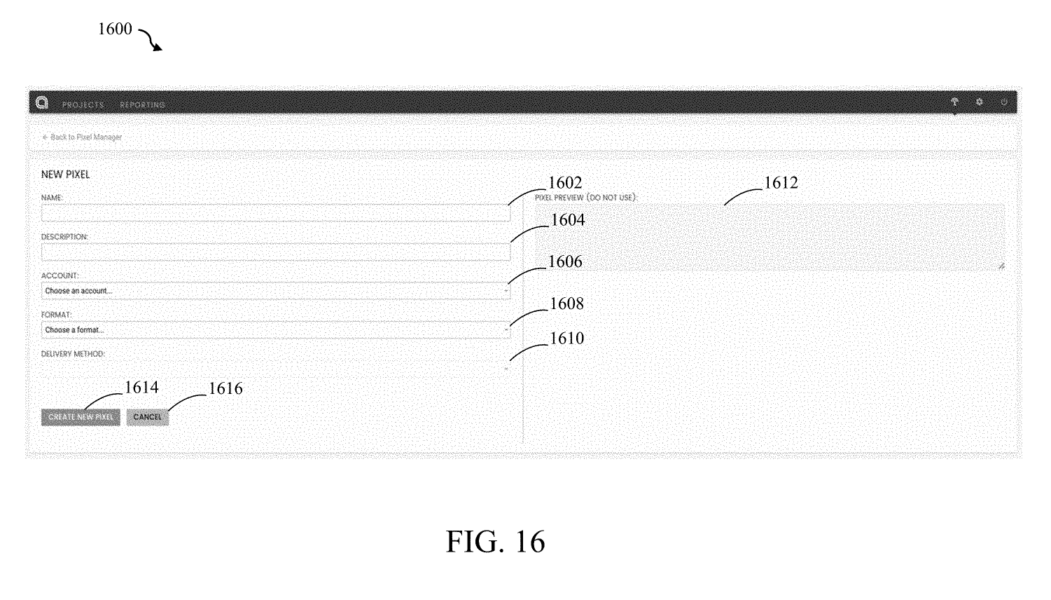

The display generator module can further be programmed to generate a create a new pixel GUI 1600, such as illustrated in FIG. 16, for example, in response to user input. The create a new pixel GUI 1600 can include a pixel name input element 1602. The user can input pixel name information (e.g., “Future Buds Website”) into the pixel name input element 1602. The create a new pixel GUI 1600 can further include a pixel description input element 1604. The user can input pixel description information (e.g., “Tracking the website where user go to see where future bud events are taking place”) into the pixel description input element 1604.

The create a new pixel GUI 1600 can further include an account drop-down element 1606. The account drop-down element 1606 can be activated by the user to provide a list of accounts. In some examples, a portion of the list of accounts can be defined by the user. The user can select a given account from the list of accounts. The create a new pixel GUI 1600 can further include a format drop-down element 1608. The format drop-down element 1608 can be activated by the user to provide a list of formats. In some examples, a portion of the list of formats can be defined by the user. For instance, the list of formats can include the format information (e.g., “website”) inputted at the format name input element 1402 of the create a new format GUI 1400, such as illustrated in FIG. 14. Thus, the user can select a given format from the list of formats. The selected given format can designate where a generated tag (e.g., pixel) can be added and/or implemented.

The create a new pixel GUI 1600 can further include a delivery method drop-down element 1610. The delivery method drop-down element 1610 can be activated by the user to provide a list of delivery methods. In some examples, a portion of the list of delivery methods can be defined by the user. For instance, the list of delivery methods can include the delivery method (e.g., “Basic website pixel”) inputted at the delivery method name input element 1502 of the new delivery method GUI 1600, such as illustrated in FIG. 15. The create a new pixel GUI 1600 can further include a pixel preview element 1612. The pixel preview element 1612 can be populated with pixel script information (e.g., pixel code, such a pixel asset tag and/or a pixel advertisement tag). In some examples, the pixel populated script information in the pixel preview element 1612 can be a secure version.

The create new pixel GUI 1600 can further include a create new pixel interface element 1614 and cancel interface element 1616. The user can activate the create new pixel interface element 1614 to save the new pixel or the cancel interface element 1616 to not save the new pixel. The CMP can be configured to save the inputted pixel name information, pixel description information, the selected given account, the selected given format, the selected deliver method and the populated script information in the memory as pixel data in response to the user activating the create new pixel interface element 1614. The pixel data can be used by one or more modules of the CMP.

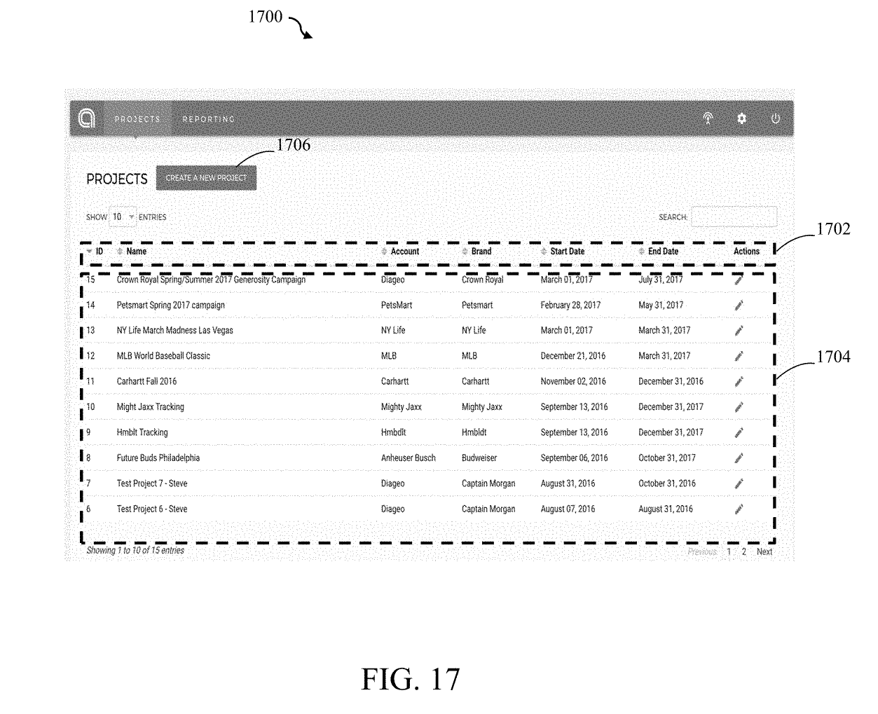

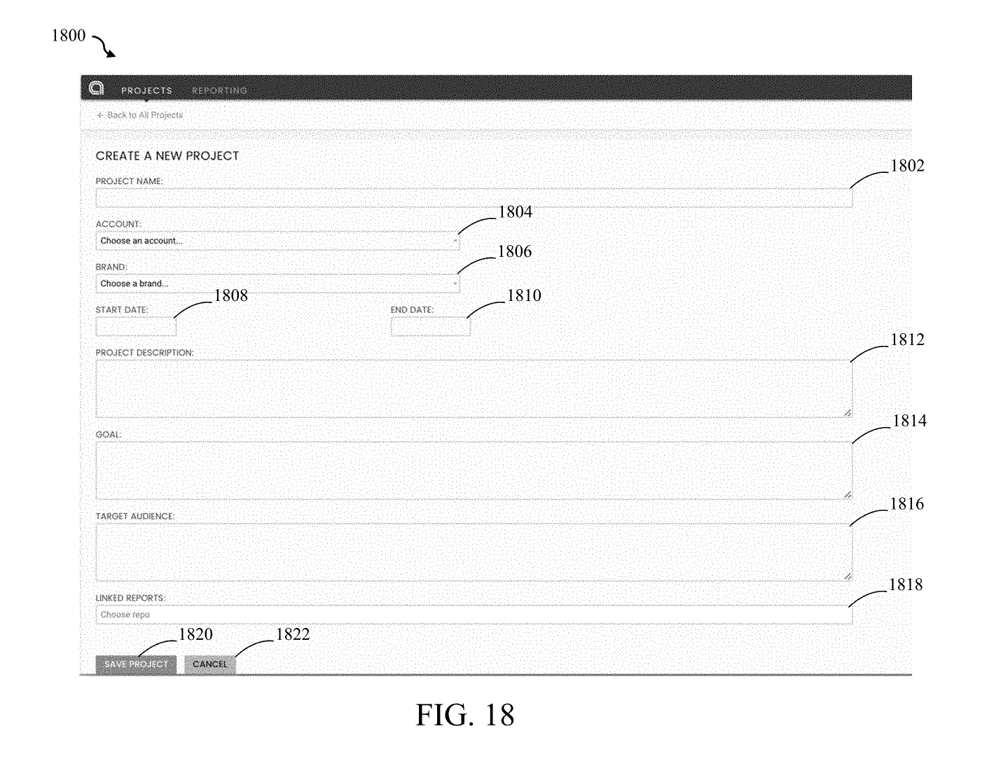

The display generator module can further be programmed to generate a project manager GUI 1700, such as illustrated in FIG. 17, for example, in response to user input. The project manager GUI 1700 can provide an overview of one or more created projects. The display generator module can be programmed to generate the project manager GUI 1700 with a list of most recent created projects. The project manager GUI 1700 can include a plurality of header text elements 1702. In some examples, the plurality of header text elements 1702 includes an ID, Name, Account, Brand, Start Date, End Date, Actions (e.g., edit). The project manager 1700 can include a create a new project interface element 1704. The display generator module can further be programmed to generate a create a new project GUI 1800, such as illustrated in FIG. 18, in response to the user activating the create a new project interface element 1706.

The create a new project GUI 1800 can include a project name input element 1802. The user can input project name information (e.g., “Budweiser Future Buds Philadelphia”) into the project name input element 1802. The create a new project GUI 1900 can further include an account drop-down element 1804. The account drop-down element 1904 can be activated by the user to provide a list of accounts. In some examples, a portion of the list of accounts can be defined by the user. Thus, the user can select a given account (e.g., Anheuser Busch) from the list of accounts.

The create a new project GUI 1800 can further include a brand drop-down element 1806. The brand drop-down element 1806 can be activated by the user to provide a list of brands. In some examples, a portion of the list of brands can be defined by the user. Thus, the user can select a given brand (e.g., Budweiser) from the list of brands. The create a new project GUI 1800 can further include a project start date element 1808 and a project end date element 1810. In some examples, the user can input project start date information (e.g., Sep. 6, 2016) into the project stop date element 1808 and project stop date information (e.g., Oct. 31, 2016) into the project stop date element 1810. Alternatively, the user can activate the project start data element 1808 by clicking with the cursor to generate a calendar graphical element on a portion of the new project GUI 1800. The user can select an appropriate start date from the calendar graphical element, and the CMP can be configured to populate the project start date element 1808 with the start date information. Furthermore, the user can activate the project stop date element 1810 by clicking with the cursor to provide the calendar graphical element. The user can select an appropriate stop date from the calendar graphical element, and the CMP can be configured to populate the project stop date element 1810 with the stop date information.

The create a new project GUI 1800 can include a project description input element 1812. The user can input project description information (e.g., “Philadelphia focused fall campaign”) into the project description input element 1812. The create a new project GUI 1800 can include a project goal input element 1814. The user can input project goal information (e.g., “Get Millennials to drink more Budweiser”) into the project goal input element 1814. The create a new project GUI 1800 can include a target audience description input element 1816. The user can input target audience description information (e.g., “Millennials Age 21-34 in the Philadelphia area”) into the target audience description input element 1816. The create a new project GUI 1800 can further include a linked report input element 1818. The user can linked report information into the linked report input element 1818.

The create a new project GUI 1800 can further include a save project interface element 1820 and cancel interface element 1822. The user can activate the save project interface element 1820 to save the new project or the cancel interface element 1822 to not save the new project. The CMP can be configured to save the inputted project name information, the selected given account, the selected given brand, the start and stop date information, project description information, project goal information and the linked report information in the memory as project data in response to the user activating the save project interface element 1820. The project data can be used by one or more modules of the CMP.

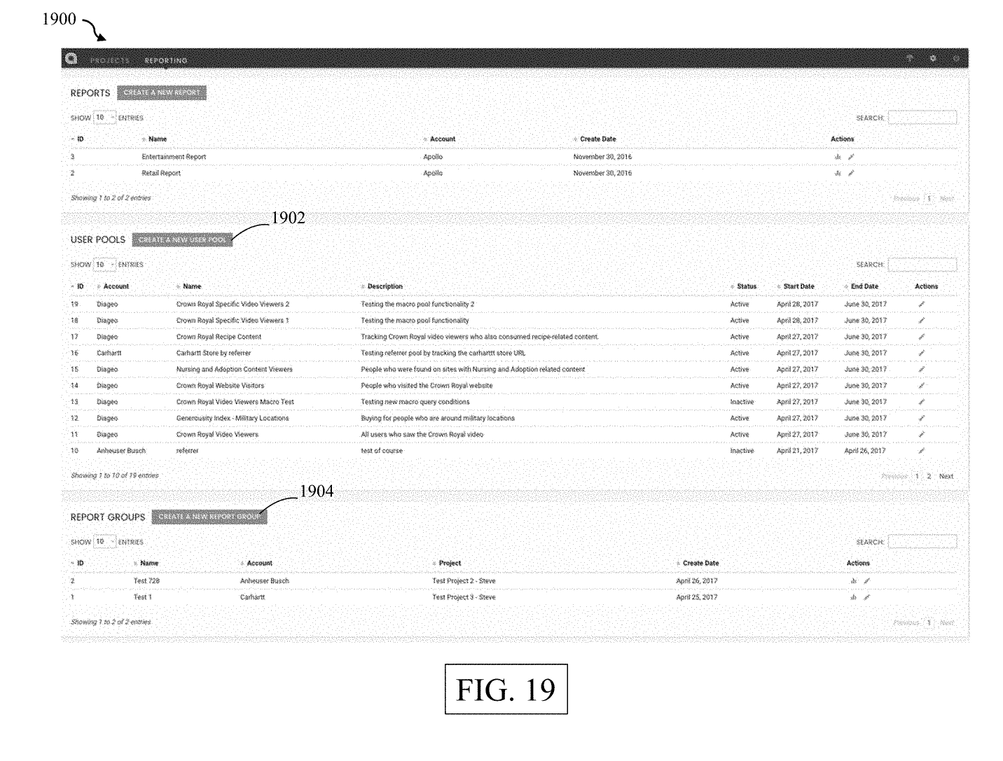

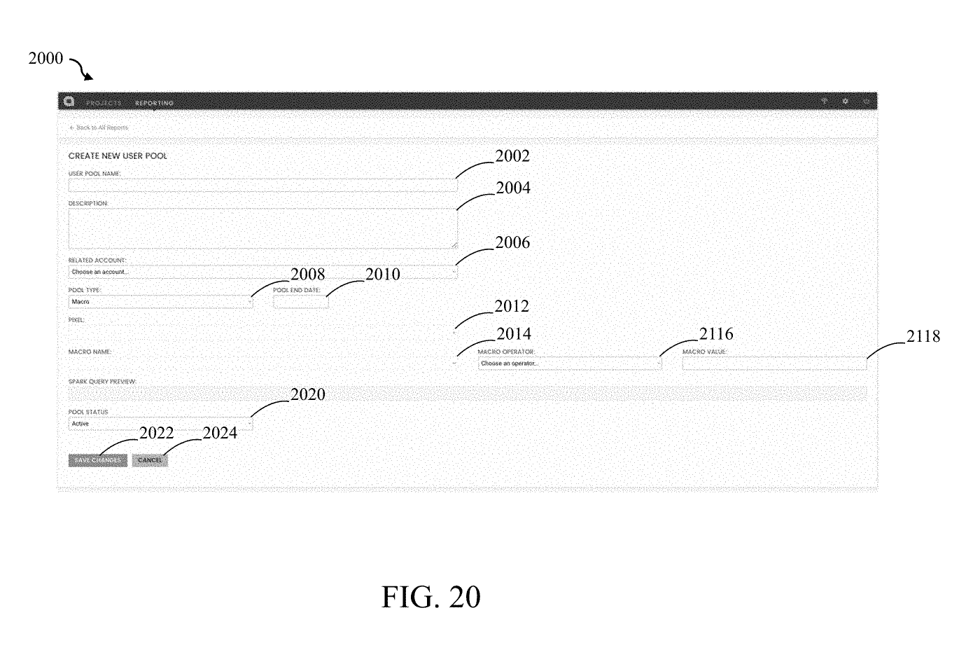

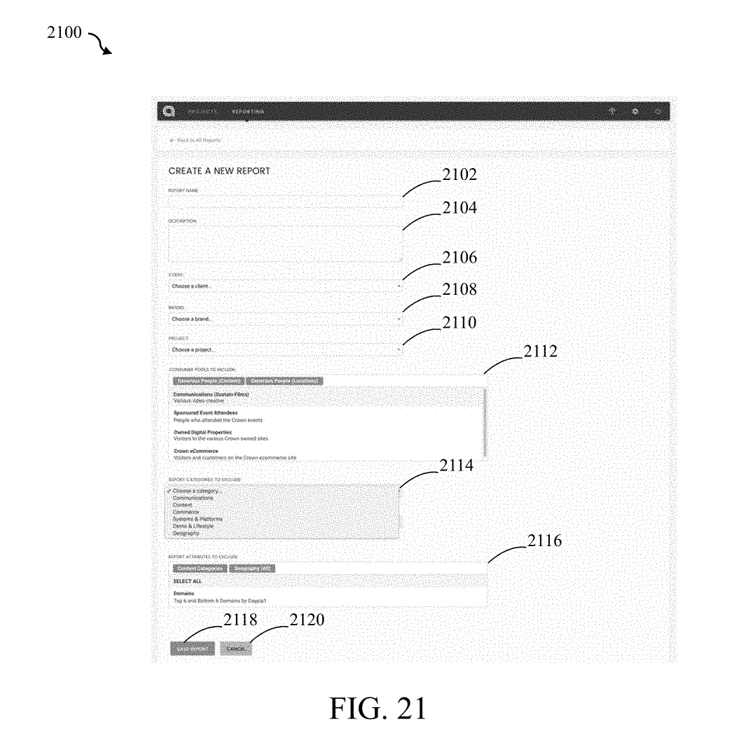

The display generator module 210 can further be programmed to generate a reporting manager GUI 1900, such as illustrated in FIG. 19, for example, in response to user input. The report manager GUI 1900 can include data characterizing active reports, user pools and report groups. The reporting manager GUI 1900 can include a new user pool element 1902. The user can activate the new user pool element 1902 to cause the display generator module to generate a create a new user pool GUI 2100, such as illustrated in FIG. 20. The reporting manager GUI 1900 can further include a create a new report group element 1904. The user can activate the create a new report group element 1904 to cause the display generator module to generate a new report group pool GUI 2100, such as illustrated in FIG. 21.

The create a new user pool GUI 2000, as illustrated in FIG. 20, can include a user pool name input element 2002. The user can input user pool name information (e.g., “People who visit Crown Royal Website”) into the user pool name input element 2002. The create a new user pool GUI 2000 can further include a pool description input element 2004. The user can input pool description information (e.g., “Any visitor of the Crown Royal website”) into the pool description input element 2004. The create a new user pool GUI 2000 can further include a related account drop-down element 2006. The related account drop-down element 2006 can be activated by the user to provide a list of related accounts. In some examples, a portion of the list of related accounts can be defined by the user. Thus, the user can select a given related account (e.g., Diageo) from the list of related accounts.

The create a new user pool GUI 2000 can further include a pool type drop-down element 2008. The pool type drop-down element 2008 can be activated by the user to provide a list of pool types. In some examples, a portion of the list of pool types can be defined by the user. Thus, the user can select a given pool type from the list of pool types. The list of pool types can include, but not limited to, a pixel, a pixel and macro, a line item ID (e.g., from buying) and a referrer. The create a new user pool GUI 2100 can further include a pool end date element 2008. In some examples, the user can input pool end date information into the pool end date element 2008. Alternatively, the user can activate the pool end date element 2008 by clicking with the cursor to provide a calendar graphical element. The user can select an appropriate pool end date from the calendar graphical element, and the CMP can be configured to populate the pool end date element 2010 with the pool end date information.

The create a new user pool GUI 2000 can further include a pixel drop-down element 2012. The pixel drop-down element 2012 can be activated by the user to provide a list of pixels based on the selected given pool type at the pool type drop-down element 2012. For example, if the pool type selected at the pool type drop-down element 2008 is pixel or pixel and macro, the list of pixels can include one or more appropriate pixels. The create a new user pool GUI 2000 can further include a macro drop-down element 2014. The macro drop-down element 2014 can be activated to provide a list of macros based on the selected given pool type at the pool type drop-down element 2008. For example, if the pool type selected at the pool type drop-down element 2008 is pixel and macro, the list of macros can include one or more appropriate macros, one of which can include a user defined macro.

The create new user pool GUI 2000 can further include a macro operator drop-down element 2016. The macro operator drop-down element 2016 can be activated to provide a list of macro operators based on the selected given pool type at the pool type drop-down element 2008. The list of macro operators can include, but not limited to, equals, not equals, start with, is null and is not null. The create new user pool GUI 2000 can further include a macro value input element 2018. The user can input macro value information (e.g., product name value such as “pants” when referring to a specific product purchased) into the macro value input element 2018. In some examples, if the pool type is a line item, the user can input in a line item ID (e.g., Line Item ID can refer to a purchase through a DSP configured to assigned and recognized DSPs)

The create a new user pool GUI 2000 can further include a state pool drop down element 2020. The state pool drop down element 2020 can include an active status and a non-active status. The user can define by a pool status for the new created user pool by selecting the active status. The create a new user pool GUI 2000 can further include a save change interface element 2022 and cancel interface element 2024. The user can activate the save change interface element 2022 to save the created new user pool or the cancel interface element 2024 to not save the created new user pool. The CMP can be configured to save the pool name information, pool description information, the selected given related account, the selected given pool type, pool end date information, the selected pixel, the selected macro, the selected macro operator, the inputted macro value information, and the selected pool status information in the memory as user pool data in response to the user activating the save change interface element 2022. The user pool data can be used by one or more modules of the CMP.

The display generator module can further be programmed to generate a create a new report GUI 2100 on the display 210, such as illustrated in FIG. 21, for example, in response to user input. The create a new report GUI 2100 can include a user report name element 2102. The user can input report name information into the user report name element 2102. The create a new report GUI 2100 can include a report description element 2104. The user can input report description information into the report description element 2104. The create a new report GUI 2100 can further include a client drop-down element 2106. The client drop-down element 2106 can be activated by the user to provide a list of client associated with the CMP. The create a new report GUI 2100 can further include a brand drop-down element 2108.

The brand drop-down element 2108 can be activated by the user to provide a list of brands created at the CMP. The create a new report GUI 2100 can further include a project drop-down element 2108. The project drop-down element 2108 can be activated by the user to provide a list of projects created at the CM P. The create a new report GUI 2100 can further include a consumer pools drop-down element 2112. The consumer pools drop-down element 2112 can be activated by the user to provide a list of consumers pools that can be included in the new report. The create a new report GUI 2100 can further include a report categories exclusion drop-down element 2114. The report categories exclusion drop-down element 2114 can be activated by the user to provide a list of categories to be excluded in the new report. The create a new report GUI 2100 can further include a report attributes exclusion drop-down element 2116. The report attributes exclusion drop-down element 2116 can be activated by the user to provide a list of attributes to be excluded in the new report.

The create a new report GUI 2100 can further include a save report interface element 2118 and cancel interface element 2120. The user can activate the save report interface element 2118 to save the report or the cancel interface element 2120 to not save the report. The CMP can be configured to save the inputted report name information, the inputted report description information, the selected client, the selected brand, the selected project, the consumers pools to include, the report categories to exclude and the report attributes to exclude in memory as report data in response to the user activating the save report interface element 2118. The user pool data can be used by one or more modules of the CMP.

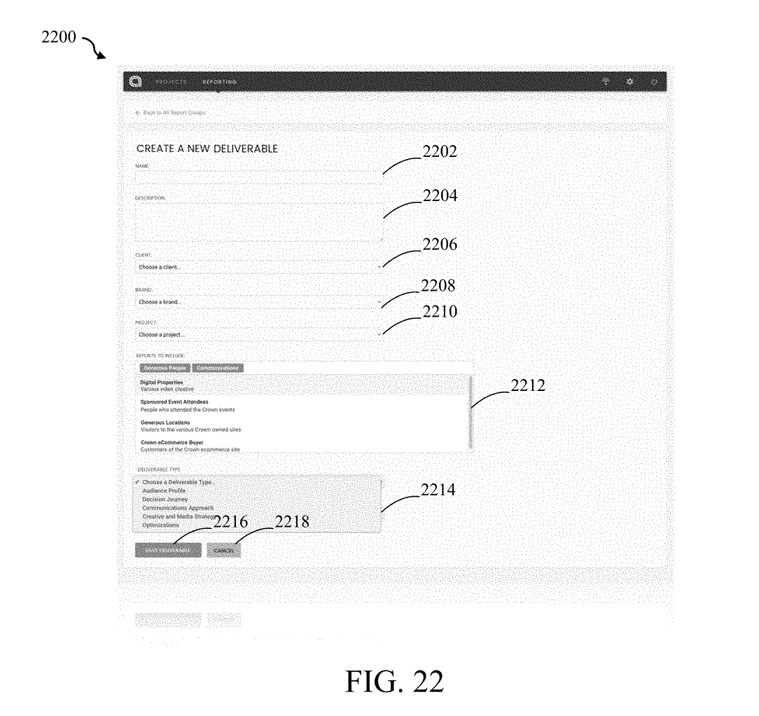

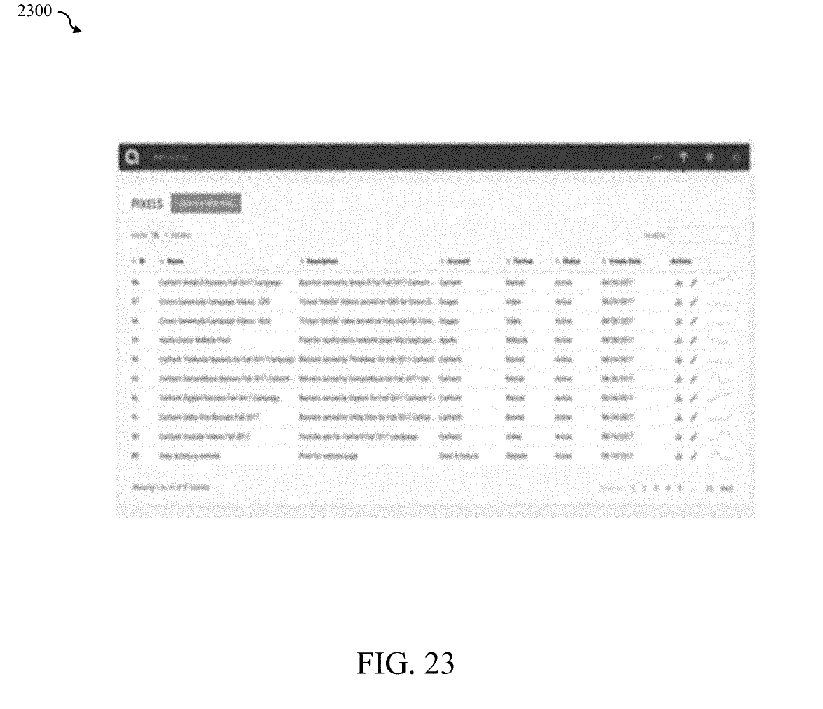

The display generator module can further be programmed to generate a create a new deliverable GUI 2200, such as illustrated in FIG. 22, for example, in response to user input. The create a new deliverable GUI 2200 can include a deliverable name element 2202. The user can input deliverable name information into the deliverable name element 2202. The create a new deliverable GUI 2200 can include a deliverable description element 2204. The user can input deliverable description information into the deliverable description element 2204. The create a new deliverable GUI 2200 can further include a client drop-down element 2206. The client drop-down element 2206 can be activated by the user to provide a list of client associated with the CMP. The create a new deliverable GUI 2200 can further include a brand drop-down element 2208. The brand drop-down element 2208 can be activated by the user to provide a list of brands created at the CMP. The create a new deliverable GUI 2200 can further include a project drop-down element 2210. The project drop-down element 2210 can be activated by the user to provide a list of projects created at the CMP.

The create a new deliverable GUI 2200 can further include a reports to include drop-down element 2212. The reports to include drop-down element 2212 can be activated by the user to provide a list of CMP generated reports that can be included in the deliverable. The create a new deliverable GUI 2200 can further include a deliverable type drop-down element 2214. The deliverable type drop-down element 2214 can be activated by the user to provide a list of deliverable types for the deliverable. The create a new deliverable GUI 2200 can further include a save deliverable interface element 2216 and cancel interface element 2218. The user can activate the save report interface element 2216 to save the deliverable or the cancel interface element 2218 to not save the deliverable. The CMP can be configured to save the inputted deliverable name information, the inputted deliverable description information, the selected client, the selected brand, the selected project, the reports to include, and the delivery type in memory as deliverable data in response to the user activating the save report interface element 2216. The deliverable data can be used by one or more modules of the CMP.

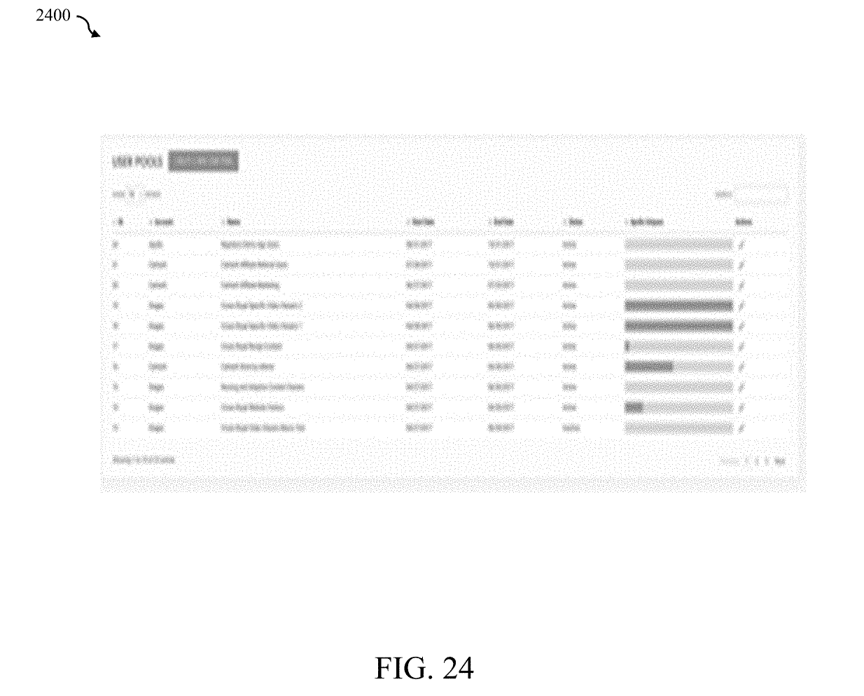

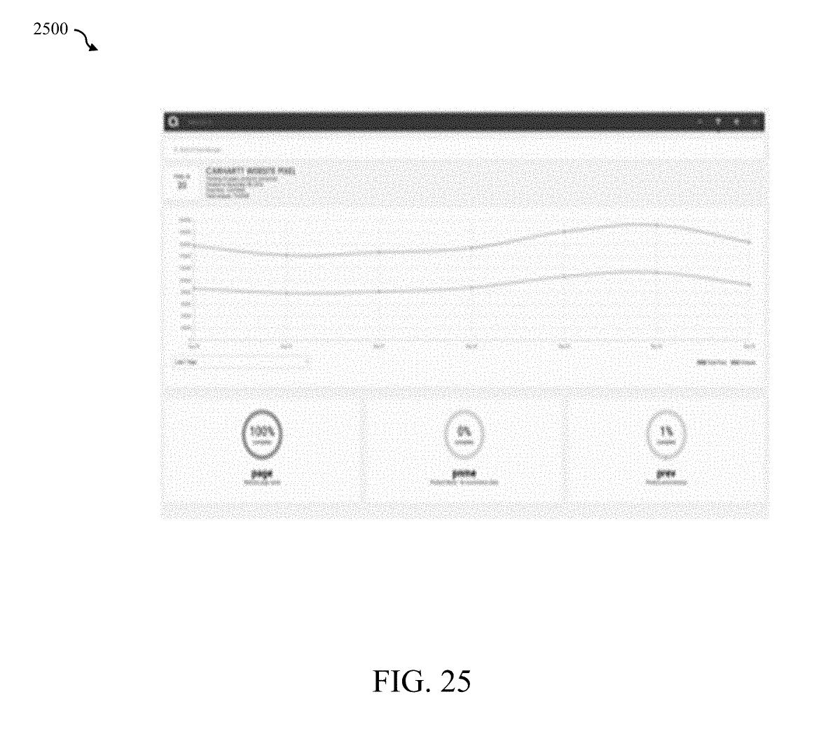

FIG. 23 illustrates an example of a user pool page 2300. The user pool page 2300 can include a list of a plurality of unique CMP IDs currently being monitored by the CMP. FIG. 24 illustrates an example of a pixel list page 2400. FIG. 25 illustrates an example of a pixel monitoring page. FIG. 25 illustrates an example of a pixel monitor page showing fires of unique CMP IDs and total fires as well as correct macro submittals.

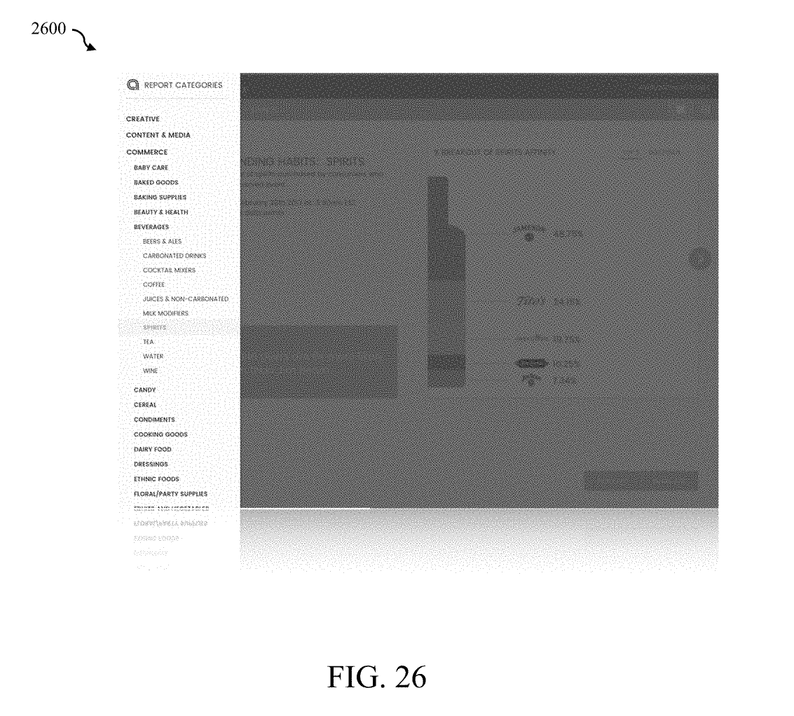

FIGS. 26-33 are directed to a plurality of GUI's illustrating the reports that can be generated by the CMP.

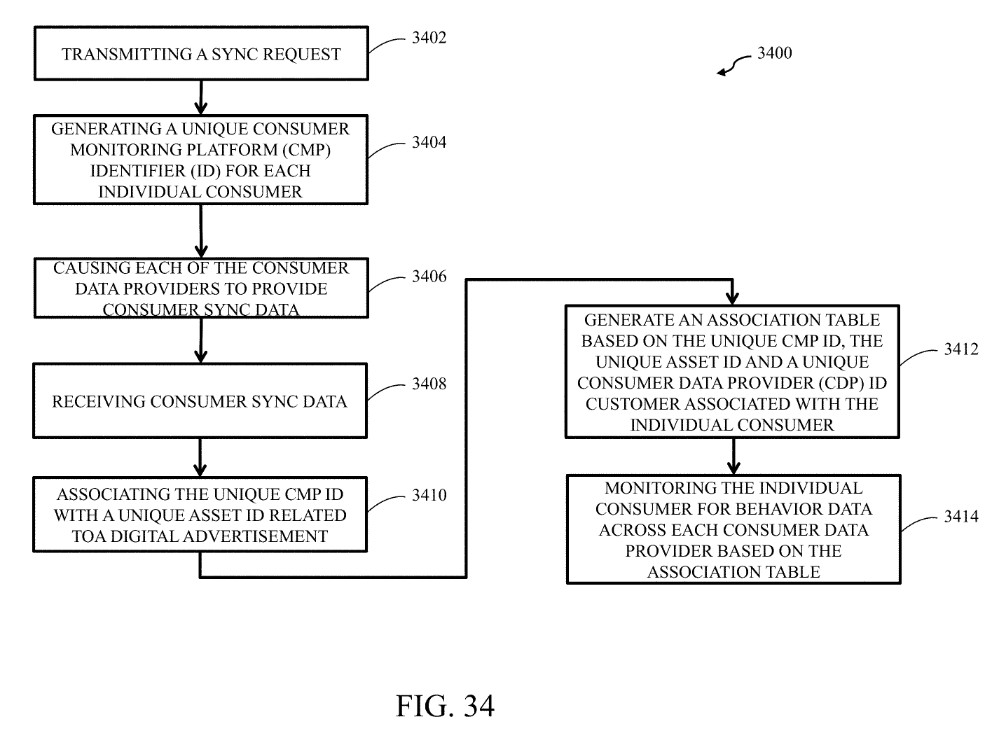

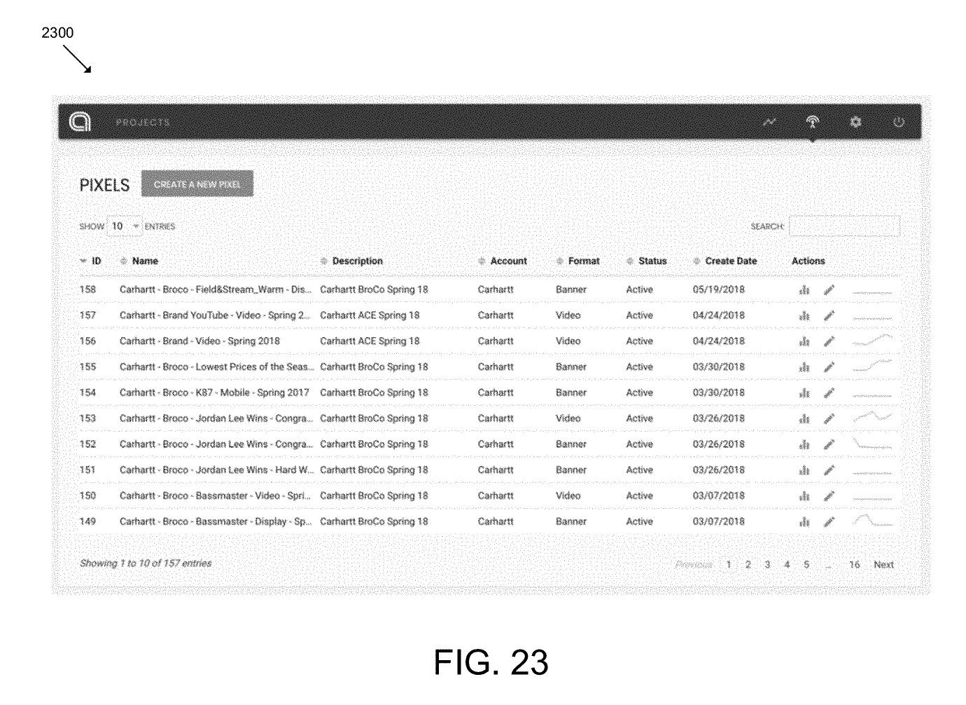

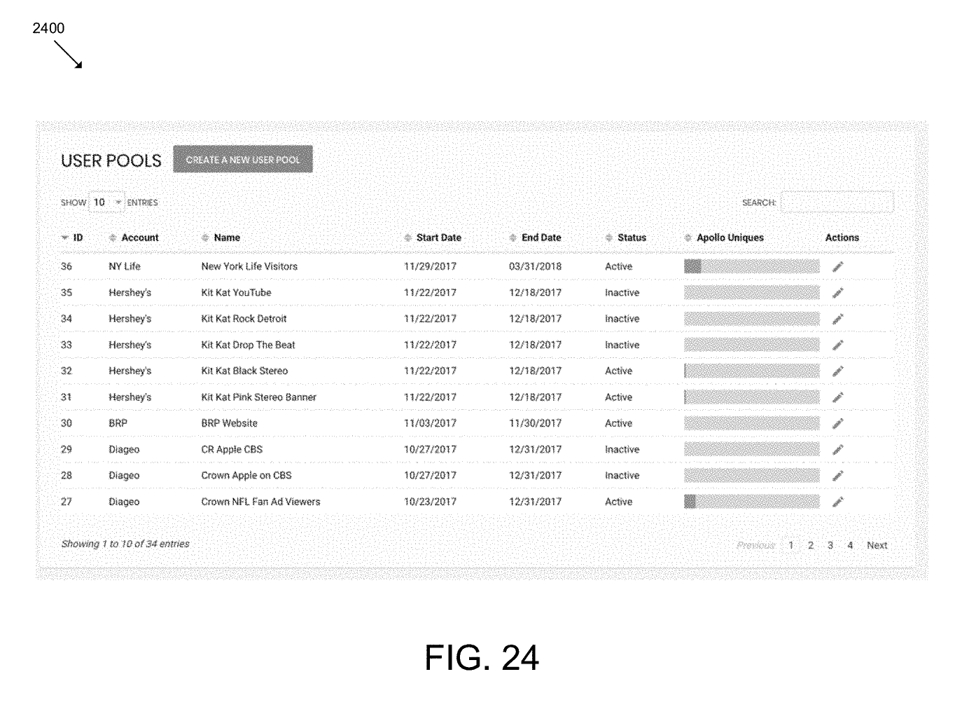

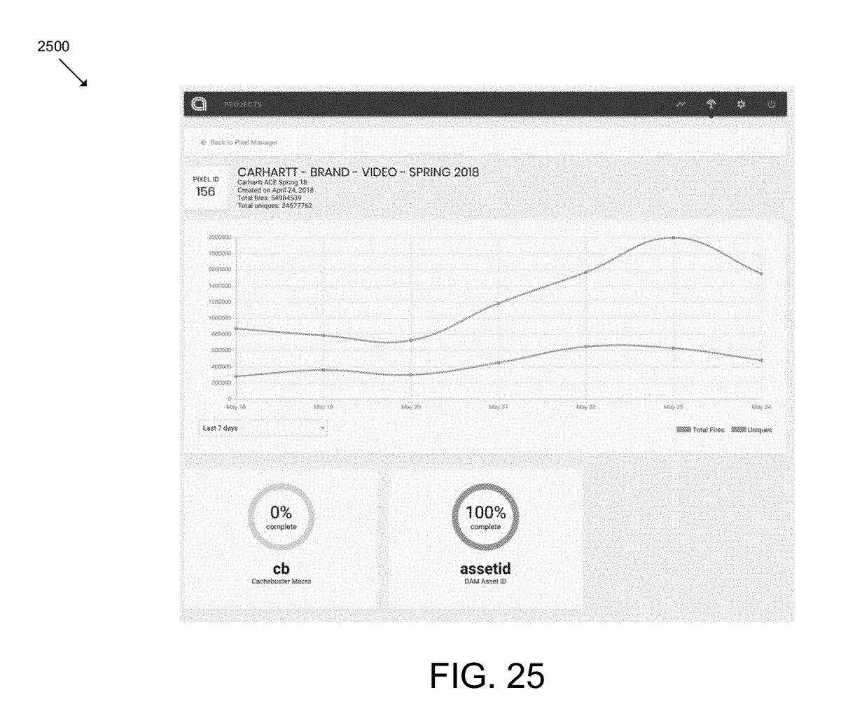

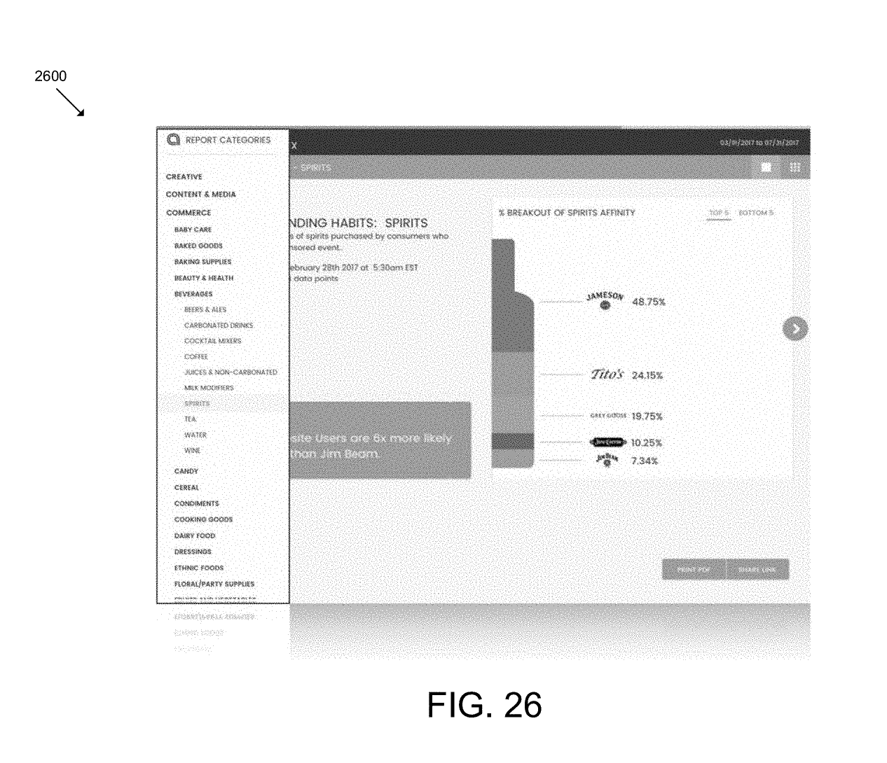

In view of the foregoing structural and functional features described above, a method that can be implemented will be better appreciated with reference to FIG. 34. While, for purposes of simplicity of explanation, the method of FIG. 34 is shown and described as executing serially, it is to be understood and appreciated that such method is not limited by the illustrated order, as some aspects could, in other examples, occur in different orders and/or concurrently with other aspects from that shown and described herein. Moreover, not all illustrated features may be required to implement a method. The method or portions thereof can be implemented as instructions stored in one or more non-transitory storage media as well as be executed by a processing resource (e.g., one or more processor cores) of a computer system, for example, the computer system 300, as illustrated in FIG. 3.

FIG. 34 depicts an example of a method 3400 for monitoring and evaluating consumer behavior data across consumer data platforms. For example, the method 3400 can be implemented by a consumer monitoring platform (CMP) (e.g., such as the CMP, as illustrated in FIG. 1, or the CMP, as illustrated in FIG. 2). The method begins at 3402 by transmitting a sync request to each consumer data provider based on CDP ID data. The CDP ID data can include a CDP ID identifying a respective CDP. Each of the CDPs can be configured to provide behavior data characterizing a behavior of the individual consumer based on one or more advertisements served to the individual consumer during an advertising campaign. At 3404, a unique consumer monitoring platform (CMP) ID for each individual consumer can be generated. At 3406, each of the CDPs can be caused to generate consumer sync data, for example in response, to a CMP (e.g., such as the CMP 102, as illustrated in FIG. 1 or the CMP 202, as illustrated in FIG. 2). The consumer sync data can characterize an association between the unique CMP ID and a unique consumer CDP ID for each individual consumer. At 3408, the consumer sync data from each of the CDPs can be received. At 3410, the unique CMP ID can be associated with a unique asset ID related to a digital advertisement asset based on the consumer sync data, such that the unique asset ID is associated with the unique customer CDP ID. At 3412, an association table characterizing the association between the unique CMP ID, the unique asset ID and the unique customer CDP ID can be generated. At 3414, the individual consumer for the behavior data across each of the consumer data providers based on the association table can be monitored.

What have been described above are examples. It is, of course, not possible to describe every conceivable combination of components or methodologies for purposes of describing the examples of the disclosure described herein, but one of ordinary skill in the art will recognize that many further combinations and permutations of the examples are possible. Accordingly, the examples described herein are intended to embrace all such alterations, modifications and variations that fall within the scope of the appended claims and the application. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.

What is claimed is:

1. A system comprising:
a non-transitory memory to store machine readable instructions; and
a processor to access the non-transitory memory and execute the machine readable instructions, the machine readable instructions comprising:
a sync and monitoring engine module programmed to:
transmit a sync request to each data provider based on consumer data provider identifier (ID) data comprising a CDP ID identifying a respective CDP, wherein each of the CDPs is configured to provide behavior data characterizing a behavior of the individual consumer based on one or more advertisements served to one or more consumer devices associated with the individual consumer during an advertising campaign;
generate a unique consumer monitoring platform (CMP) ID for each individual consumer;
cause each of the CDPs to generate consumer sync data, wherein the consumer sync data characterizes an association between the unique CMP ID and a unique consumer CDP ID for each individual consumer;
receive the consumer sync data generated at each of the CDPs;
associate the unique CMP ID with a unique asset ID related to a digital advertisement asset based on the consumer sync data, such that the unique asset ID is associated with the unique customer CDP ID;
generate an association table characterizing the association between the unique CMP ID, the unique asset ID and the unique customer CDP ID; and
monitor the individual consumer for the behavior data across each of the consumer data providers based on the association table.

2. The system of claim 1, wherein the machine readable instructions further comprise a page tag module programmed to generate for each advertisement served during the advertising campaign to the one or more consumer devices associated with individual consumer by each of the CDPs a CMP page tag based on the unique CMP ID.

3. The system of claim 2, wherein the CMP tag comprises one of a CMP pixel tag and a JavaScript CMP tag.

4. The system of claim 3, wherein the CMP pixel tag is represented as a 1×1 uniform resource locator (URL) script, and the JavaScript CMP tag is represented in Java script form.

5. The system of claim 4, wherein CMP page tag comprises one or more tag properties, wherein the one or more tag properties comprises a name, a description, an account, a format, a delivery method, a create date, and/or a combination thereof.

6. The system of claim 2, wherein the machine readable instructions further comprise an asset module programmed to generate for each digital asset of the advertisement served during the advertising campaign to the one or more consumer devices associated with individual consumer by each of the CDPs a CMP asset tag based on the unique asset ID.

7. The system of claim 6, wherein the sync and monitoring engine module is further programmed to transmit each of the asset tags and the page tags to a corresponding CDP and cause each CDP to facilitate serving of the digital asset and the advertisement, such that during the serving, the CMP page tag is served with the advertisement and the CMP asset tag is served with the digital asset, to each consumer device associated with the individual consumer.

8. The system of claim 7, wherein the sync and monitoring engine module is further programmed to receive a tag notification comprising the unique CMP ID in response to the serving of the CMP page tag.

9. The system of claim 8, wherein the sync and monitoring engine module is further programmed to receive an asset notification comprising the unique asset ID in response to the serving of the CMP asset tag.

10. The system of claim 9, wherein the machine readable instructions further comprise an evaluation engine module programmed to evaluate the unique CMP ID of the tag notification and the unique asset ID of the asset notification relative to the association table to determine the unique customer CDP ID for the individual consumer for each CDP during the advertising campaign.

11. The system of claim 10, wherein the evaluation engine module is further programmed to communicate a consumer data request to each of the CDPs based on the evaluation, wherein the consumer data request comprises the unique customer CDP ID associated with the individual consumer data for the individual consumer for each CDP.

12. The system of claim 12, wherein evaluation engine module is further programmed to receive the consumer behavior data for the individual consumer for each CDP, wherein the consumer behavior data comprises consumer asset data generated based on the CMP asset tag.

13. The system of claim 11,
wherein the unique customer CDP ID comprises a WebID, a device ID, or a combination therefor; and
wherein the unique customer CDP ID is associated with the consumer behavior data for the individual consumer at a respective consumer data provider.

14. A computer-implemented method comprising:
transmitting a sync request to each consumer data provider based on consumer data provider (CDP) identifier (ID) data comprising a CDP ID identifying a respective CDP, wherein each of the CDPs is configured to provide behavior data characterizing a behavior of the individual consumer based on one or more advertisements served to one or more consumer devices associated with the individual consumer during an advertising campaign;
generating a unique consumer monitoring platform (CMP) ID for each individual consumer;
causing each of the CDPs to generate consumer sync data, wherein the consumer sync data characterizes an association between the unique CMP ID and a unique consumer CDP ID for each individual consumer;
receiving the consumer sync data generated at each of the CDPs;
associating the unique CMP ID with a unique asset ID related to a digital advertisement asset based on the consumer sync data, such that the unique asset ID is associated with the unique customer CDP ID;
generating an association table characterizing the association between the unique CMP ID, the unique asset ID and the unique customer CDP ID; and
monitoring the individual consumer for the behavior data across each of the consumer data providers based on the association table.

15. The computer-implemented method of claim 14 further comprising generating for each advertisement served during the advertising campaign to the one or more consumer devices associated with individual consumer by each of the CDPs a page tag based on the unique CMP ID.

16. The computer-implemented method of claim 15 further comprising generating for each digital asset of the advertisement served during the advertising campaign to the one or more consumer devices associated with individual consumer by each of the CDPs a CPM asset tag based on the unique asset ID.

17. The computer-implemented method of claim 16 further comprising transmitting each of the asset tags and the page tags to a corresponding CDP and cause each CDP to facilitate serving of the digital asset and the advertisement, such that during the serving, the CMP page tag is served with the advertisement and the CMP asset tag is served with the digital asset, to each consumer device associated with the individual consumer.

18. The computer-implemented method of claim 17 further comprising:
receiving a tag notification comprising the unique CMP ID in response to the serving of the CMP page tag; and
receiving an asset notification comprising the unique asset ID in response to the serving of the CMP asset tag.

19. The computer-implemented method of claim 18 further comprising:
evaluating the unique CMP ID of the tag notification and the unique asset ID of the asset notification relative to the association table to determine the unique customer CDP ID for the individual consumer for each CDP during the advertising campaign; and
communicating a consumer data request to each of the CDPs based on the evaluation, wherein the consumer data request comprises the unique customer CDP ID associated with the individual consumer data for the individual consumer for each CDP.

20. The computer-implemented method of claim 19 further comprising:
receiving the consumer behavior data for the individual consumer at the respective CPD, wherein the consumer behavior data comprises consumer asset data generated based on the CMP asset tag, wherein the unique customer CDP ID comprises a WebID, a device ID, or a combination therefor, and wherein the unique customer CDP ID is associated with the consumer behavior data for the individual consumer at a respective consumer data provider.
